(19) United States
(12) Patent Application Publication
(10) Pub. No.: US 2025/0307609 A1
(43) Pub. Date: Oct. 2, 2025

(54) HIGH-QUALITY ENGAGEMENT CONTENT ITEM UNROLLING

(71) Applicant: Microsoft Technology Licensing, LLC, Redmond, WA (US)

(72) Inventors: Don Woods, San Francisco, CA (US); Lamia Tounsi, Ashbourne (IE); Isabell Seeger, Dublin (IE); Derek Thomas Kelleher, Dublin (IE); Mitiku Yohannes Fuge, Dublin (IE); Nicolau Augusto Barata Gonçalves, Dun Laoghaire (IE); Igor Lapchuk, Dublin (IE)

(21) Appl. No.: 18/620,888

(22) Filed: Mar. 28, 2024

(51) Int. Cl. G06N 3/0455

(52) U.S. Cl. CPC G06N 3/0455

(57) ABSTRACT

Techniques for high-quality engagement content item unrolling. The techniques enhance user engagement within multi-user application systems by leveraging large language model (LLM) prompts to generate engagement content items in response to anchor content items, such as social media posts. This involves selecting relevant engagement content from LLM-generated completions, training a dialogue classifier with examples of these anchor and engagement content pairings, and using the classifier to score each dialogue based on its quality or relevance. Dialogues that achieve a high score are then selected, and their corresponding engagement content items are highlighted within the application's graphical user interface.

### BACKGROUND

There exists a technical challenge of enhancing user engagement and interaction quality within multi-user application systems, such as social media and professional network platforms. Traditional engagement metrics often rely on simplistic measures like the number of likes, shares, or comments, which do not necessarily reflect the quality or relevance of interactions. This can lead to a proliferation of low-quality content, diminishing user experience and engagement. Furthermore, manually curating and highlighting engaging content is labor-intensive and not scalable for large platforms with vast amounts of user-generated content.

### BRIEF DESCRIPTION OF THE DRAWINGS

The following detailed description of certain embodiments of the invention are understood by reference to the following figures:

FIG. 1 illustrates an example system and method for high-quality engagement content item unrolling.

FIG. 2 illustrates an example large language model prompt for high-quality engagement content item unrolling.

FIG. 3 illustrates examples of large language model generated engagement content items for high-quality engagement content item unrolling.

FIG. 4 illustrates an example architecture of a dialog classifier for high-quality engagement content item unrolling encompassing two bidirectional encoder representations from transformers models.

FIG. 5 illustrates an example architecture of a dialog classifier for high-quality engagement content item unrolling encompassing one bidirectional encoder representations from transformers model.

FIG. 6 illustrates an example feed item graphical user interface for high-quality engagement content item unrolling presenting an example highlighted engagement content item.

FIG. 7 illustrates an example electronic mail message item graphical user interface classifier for high-quality engagement content item unrolling presenting an example highlighted engagement content item.

FIG. 8 illustrates an example notifications item graphical user interface classifier for high-quality engagement content item unrolling presenting an example highlighted engagement content item.

FIG. 9 illustrates an example multi-user application system in which the techniques disclosed herein for high-quality engagement content item unrolling are implemented.

FIG. 10 illustrates an example programmable electronic device that processes and manipulates data to perform the techniques disclosed herein for high-quality engagement content item unrolling.

### DETAILED DESCRIPTION

Systems, methods, non-transitory computer-readable media, and graphical user interfaces (generally referred to herein as “the techniques”) are disclosed for high-quality engagement content item unrolling. The disclosed techniques solve the issues mentioned in the background section above by automating the process of identifying and promoting high-quality, relevant interactions (engagement content items) in response to original posts (anchor content items). By using a large language model (LLM) to generate example engagement content and training a dialogue classifier on the generated examples, a multi-user application system, such as a social media or professional networking platform, can objectively score dialogues for their engagement quality. This approach allows for the automated selection and highlighting of content that is likely to foster meaningful interaction, thereby enhancing overall user engagement and satisfaction without the need for manual curation.

The technical problem addressed by the disclosed techniques involves the challenge of generating a sufficient and diverse number of training examples for training the dialogue classifier, a task where prior solutions fell short. Conventional approaches to gathering training data for dialogue classifiers often relied on crowdsourcing or manually curating datasets, which can be time-consuming, costly, and may not yield the desired diversity in dialogue examples. This diversity is important for the effective training of classifiers to handle a wide range of conversational contexts and nuances.

The solution proposed leverages large language models (LLMs) with carefully crafted prompts to generate a diverse set of completions, which serve as engagement content items paired with anchor content items to form dialogue examples. By using LLMs in this manner, the techniques bypass the limitations of previous approaches by automating the generation of dialogue examples. This not only substantially increases the volume and variety of training data available but also significantly reduces the dependency on crowdsourced examples, which can be prone to biases and variability in quality. Furthermore, the use of LLM-generated content ensures a continuous and scalable source of training examples, tailored to the specific requirements of the dialogue classifier being trained.

The techniques address the challenge of data scarcity and lack of diversity in training materials for dialogue classifiers. By utilizing LLMs to produce relevant and varied dialogue examples, the techniques enhance the classifier's ability to understand and score dialogues effectively. This results in more accurate and nuanced engagement between users and content, as the trained classifier can better select engagement content items that are likely to be relevant and engaging to the users, thereby improving the overall user experience in digital platforms where such dialogues are presented.

The techniques facilitate the generation of a diverse set of training examples, which is useful for fostering discussions that incorporate a multitude of viewpoints. By leveraging large language models (LLMs) prompted with a carefully curated set of prompts, the techniques are able to produce a wide array of completions, each corresponding to different engagement content items that are paired with anchor content items to create rich, varied dialogue examples. This diversity in training examples is useful, as it exposes the dialogue classifier to a broad spectrum of conversational contexts, styles, and topics during its training phase.

Such exposure equips the classifier with the nuanced understanding required to effectively score and select engagement content items that reflect a wide range of perspectives. This is useful in digital platforms where engagement and discussion are encouraged, as it allows for the representation of diverse viewpoints, thereby enriching the conversation and promoting a more inclusive dialogue. The generation of training examples through LLMs, as proposed, eliminates the constraints of traditional data collection methods, which often struggle to capture the full breadth of human conversation diversity. Consequently, the techniques not only enhance the classifier's performance but also supports a more vibrant and comprehensive discussion environment by ensuring that diverse perspectives are considered and highlighted in the selection of engagement content items.

In an embodiment, the techniques address the enhancement of user engagement within the multi-user application system by intelligently identifying and highlighting high-quality engagement content items (e.g., comments) in response to anchor content items (e.g., posts). This process begins with generating a variety of example engagement responses using prompts for the LLM. The dialogue classifier is then trained using the LLM generated examples, enabling the system to evaluate and score dialogues for quality and relevance. Based on these scores, the system uses the trained dialog classifier to select particularly engaging content items to be prominently displayed in the application's graphical user interface. This method aims to foster a more engaging and interactive user environment by automatically surfacing content that is likely to stimulate further user interaction and engagement.

In an embodiment, the techniques encompass generating example engagement content items for training the dialog classifier using LLM prompts in the multi-user application system. This refinement involves each LLM prompt being precisely crafted to instruct the LLM to generate a specific number of engagement content items for a corresponding anchor content item, such as a social media post. Furthermore, each prompt is enriched with a set of engagement content item specifications, detailing the desired features of the engagement content items to be generated. These specifications can dictate various aspects of the content, such as tone, style, or thematic elements, ensuring that the generated engagement content items are closely aligned with the context and objectives of the anchor content item. This approach produces more relevant, engaging, and contextually appropriate content for training the dialogue classifier.

In an embodiment, the techniques encompass specifying the attributes that can be defined in the engagement content item specifications for prompts used with the LLM. The customization of engagement content items through detailed feature specifications includes any or all of: the desired length of the content, the requirement for the content to address specific points or the overall topic of the anchor content, the encouragement of social interaction with the content's author, and preferences for the depth and tone of the engagement content. These specifications aim to ensure that the LLM generated content is not only contextually relevant and engaging but also aligns with the intended interaction dynamics and atmosphere of the discussion within the multi-user application system. This approach allows for a more nuanced and tailored generation of engagement content by the LLM.

In an embodiment, the dialogue classifier is constituted by two distinct trained models based on the Bidirectional Encoder Representations from Transformers (BERT) architecture, along with a trained fully connected layer. The process of determining dialogue scores involves a dual-input mechanism where the engagement content item (e.g., a comment) for a given dialogue is processed through the first BERT model, and the corresponding anchor content item (e.g., a social media post) is processed through the second BERT model. This bifurcated approach allows for a nuanced analysis of both components of the dialogue, leveraging the strengths of BERT models in understanding and encoding natural language nuances. The output from both BERT models can then be synergized, through the trained fully connected layer, to calculate a dialogue score that reflects the quality, relevance, and potential engagement value of the interaction between the user-generated content and its engagement responses.

In an alternative to the previous embodiment, the architecture of the dialogue classifier is simplified compared the previous embodiment by consolidating it into a single trained Bidirectional Encoder Representations from Transformers (BERT) model, in addition to a trained fully connected layer. The operational process for determining dialogue scores involves inputting both the engagement content item (e.g., a comment) and the anchor content item (e.g., a social media post) simultaneously into the same BERT model. This integrated approach allows the BERT model to analyze the interaction between the anchor and engagement content items in a unified context, leveraging its deep learning capabilities to understand and encode the nuances of natural language within the dialogue. The dialogue score is then derived, reflecting the relevance and potential engagement quality of the content interaction.

In an embodiment, the channels through which the selected engagement content items are presented include any or all of: as part of a feed item, within notifications, or through an electronic mail message item. The inclusion of these mediums suggests a versatile approach to maximizing visibility and engagement with high-quality interactions. By highlighting engaging content in users' feeds, notifications, or emails, the system ensures that noteworthy interactions are prominently displayed, thereby increasing the likelihood of further engagement from users.

In an embodiment, each dialogue example used to train the dialogue classifier corresponds to a specific anchor content item and includes an engagement content item generated by the large language model for that specific anchor content. This structured pairing facilitates targeted training of the dialogue classifier, ensuring it learns from direct correlations between anchor content items and their generated engagement content items. Each example is associated with a label from a set of labels. These labels indicate whether the engagement content item within each dialogue example constitutes an insightful comment on the corresponding anchor content item. This labeling process is useful for the dialogue classifier's training, enabling it to discern and score dialogues based on the presence of insightful engagement. Through this approach, the classifier's larges the ability to evaluate the quality of interactions within the platform, focusing on the insightful nature of comments as a measure of engagement quality.

The foregoing and other embodiments will now be described with respect to the figures.

### Example Method for High-Quality Engagement Content Item Unrolling

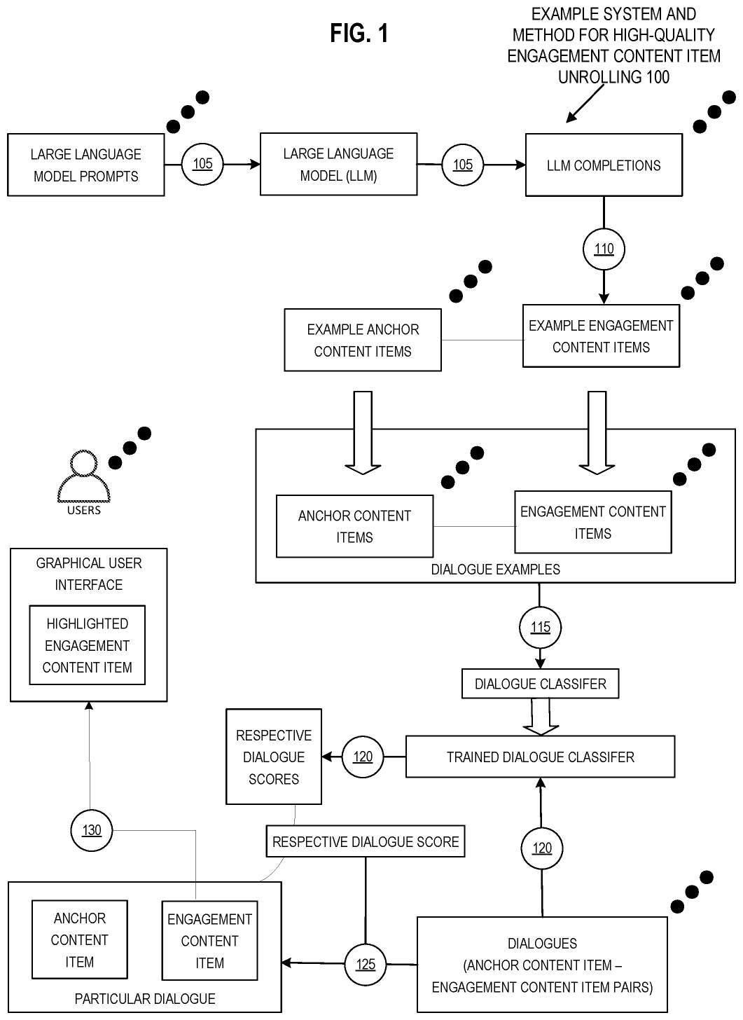

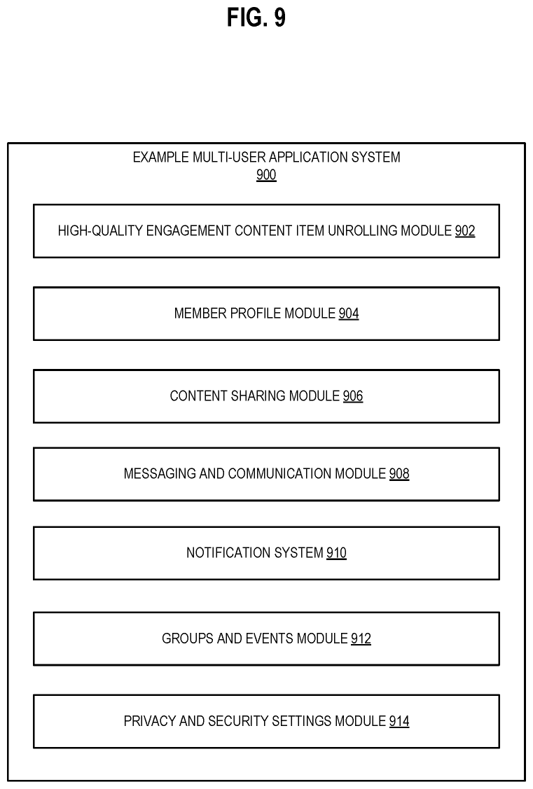

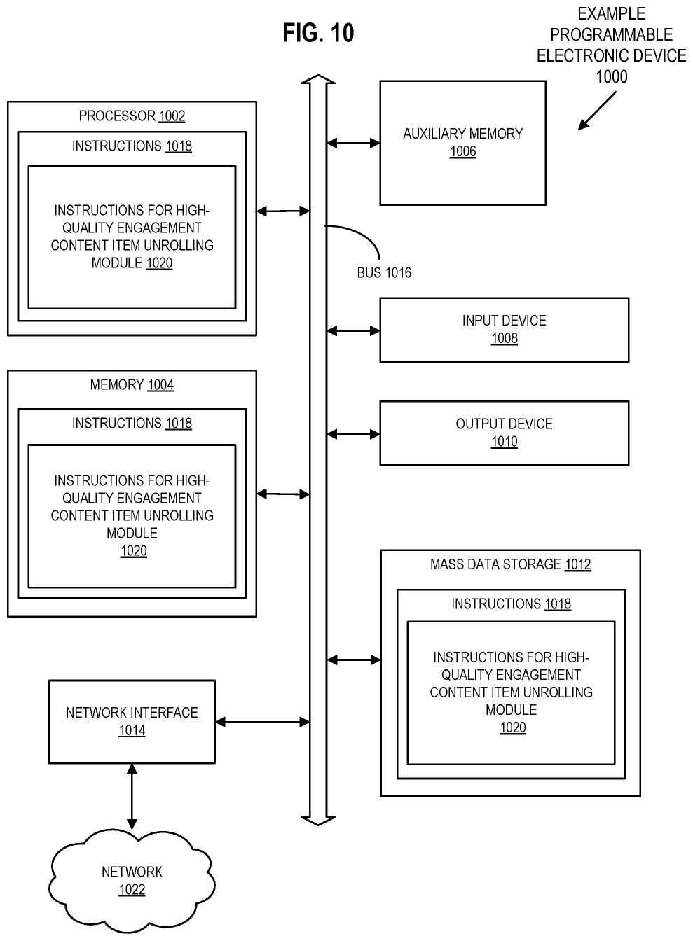

FIG. 1 illustrates an example system and method 100 for high-quality engagement content item unrolling. The system and method 100 in an embodiment is implemented by one or more programmable electronic devices (e.g., example programmable electronic device 1000 of FIG. 10) that implement a multi-user application system (e.g., example multi-user application system 900 of FIG. 9.)

System and method 100 introduce several beneficial technical effects to the multi-user application system, primarily enhancing user engagement and interaction quality. By leveraging large language model prompts to generate a diverse set of engagement content items for anchor content items, the system can train the dialogue classifier to identify content that is likely to be engaging to users. The training of the dialogue classifier on the examples comprising both anchor and engagement content items allows for the nuanced evaluation of dialogue quality, enabling the system to discern and prioritize interactions that are most relevant and engaging to the community.

The use of this trained classifier to assign dialogue scores to each interaction facilitates an automated, intelligent selection process for highlighting content within the application's graphical user interface. By focusing on content with higher dialogue scores, the system ensures that users are presented with the most engaging and high-quality interactions, increasing user retention, and encouraging more active participation. The ability to automatically identify and promote such content not only enhances the user experience by making the platform livelier and more interesting, but also reduces the need for manual curation of content, thereby improving operational efficiency.

Furthermore, the system and method 100's application within the multi-user system means these benefits are scalable across various types of content and interaction modes, from social media and professional networking posts and comments to more structured dialogues in forums or messaging platforms. This versatility ensures that the technical effects of improved engagement and interaction quality have broad applicability, enhancing the value of the platform for a wide range of users and use cases.

At a high level, the system and method 100 uses 105 a set of prompts to direct a large language model (LLM) to produce a variety of completions, from which a set of engagement content items is obtained 110 for specific anchor content items (e.g., social media posts). In this context, a “completion” is a piece of text generated by the LLM in response to a specific prompt, serving as engagement content that is paired with an anchor content item to form a dialogue example for training and evaluating the dialogue classifier. These engagement content items, and anchor content items form a dataset of dialogue examples used to train 115 a dialogue classifier. The trained classifier is then used 120 to assign a dialogue score to each dialogue within a set of dialogues, effectively evaluating the quality and relevance of the interactions. Based on these scores, the system selects 125 an engagement content item for a particular dialogue deemed to have a high engagement quality. Finally, this selected engagement content item is highlighted 130 within the application's graphical user interface, ensuring it gains visibility among users. This method aims to foster a more interactive and engaging user environment by automatically surfacing content that is likely to encourage further user interaction and engagement.

Presenting the selected engagement content item in a graphical user interface as a highlighted engagement content item can take various forms, depending on the platform and the design of the user interface. For example, in an online forum or social media platform, the highlighted engagement content item might appear as a pinned post or comment at the top of a discussion thread, visually distinguished by a different background color or a special icon to signal its importance or relevance. In a news aggregation app, it could manifest as a featured reader comment or response that is displayed prominently alongside or within the article summary, perhaps encased in a border or shadow box to draw attention. For educational platforms, the engagement content items selected by the classifier could be presented as thought-provoking questions or insights related to the lesson content, placed in sidebar widgets or pop-ups that encourage interactive learning.

Returning to the top of the system and method 100, the step of using 105 a set of large language model prompts to prompt a large language model (LLM) to generate a set of completions involves crafting specific prompts that are fed into the LLM. These prompts are designed to elicit responses from the LLM that serve as potential engagement content items in relation to given anchor content items, such as social media posts. The nature of these prompts can vary widely, depending on the objectives of the engagement content to be generated, but they are all aimed at producing diverse and relevant responses that can simulate or inspire real user interactions. This step leverages the LLM's ability to process natural language and generate coherent, contextually relevant completions that mimic the way humans might respond to or engage with the anchor content items. The generated completions are then curated to obtain a set of engagement content items used to train the dialogue classifier.

The LLM used to generate the completions can be any advanced model capable of understanding context, generating coherent and contextually relevant text, and being prompted in a way that allows for the generation of specific types of completions. Models such as GPT (Generative Pre-trained Transformer), BERT (Bidirectional Encoder Representations from Transformers), or their successors and variations, which have been fine-tuned for specific tasks or to understand certain domains more deeply, are suitable. These models excel in processing natural language inputs and generating outputs that can mimic human-like understanding and responses. The choice of LLM could depend on the complexity of the dialogue interactions, the need for domain-specific knowledge, and the desired quality and variability of the engagement content items. For example, GPT models, known for their generative capabilities, could be used to create diverse and engaging responses to prompts based on anchor content items.

Additionally, BERT and its derivatives, which are excellent at understanding context and nuance in language, could be used to refine the selection of generated content. The useful characteristic of the LLM used in method 110 is its ability to generate high-quality, relevant text that can serve as engagement content in a wide range of interaction scenarios within the multi-user application system.

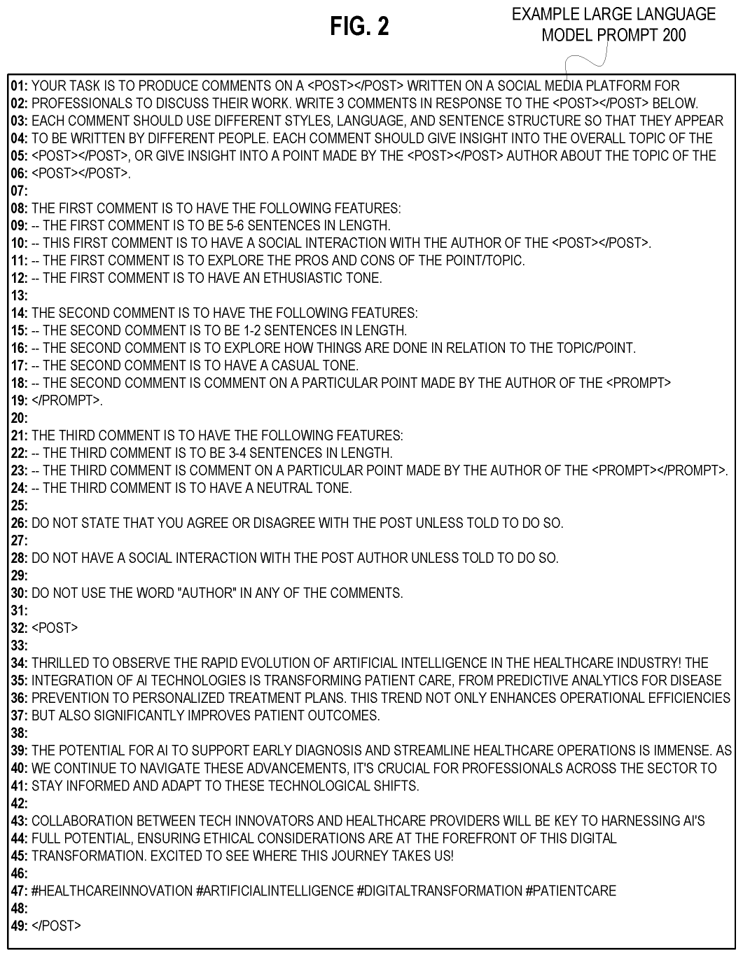

In an embodiment, prompting the Large Language Model (LLM) to generate completions involves creating and submitting specific queries or statements designed to elicit responses that can serve as engagement content items for various anchor content items, such as social media or professional networking posts. These prompts are carefully crafted to align with the nature and context of the anchor content, guiding the LLM to produce outputs that are relevant and suitable for fostering engagement among users. For example, if the anchor content is a social media post about environmental conservation, the prompt might be structured to ask the LLM for comments that express support, ask thoughtful questions, or provide additional insights on the topic. The prompts can also specify the tone, style, and even the desired length of the completions to ensure they match the platform's and users' expectations. This process takes advantage of the LLM's advanced natural language understanding and generation capabilities, allowing it to produce a wide array of potential engagement content items that reflect the diversity of human reactions and interactions. The quality and relevance of these generated completions depend on the specificity and clarity of the prompts, as well as the LLM's training data and its ability to interpret and respond to the prompts in a human-like manner. An example LLM prompt is described in greater detail below with respect to FIG. 2.

After using 105 large language model (LLM) prompts to generate a set of completions, the next step of the system and method 100 involves obtaining 110 a set of engagement content items from these completions for a predefined set of anchor content items, such as social media or professional networking posts. This process essentially filters and selects from the LLM-generated responses some, all, or those that are most appropriate and relevant as potential engagement responses to the anchor content. If a subset is selected, the selection criteria can be based on relevance to the topic, alignment with the intended tone or style, and potential to stimulate further discussion or interaction among users. The aim is to curate a collection of generated texts that can serve as example comments, replies, or other forms of engagement that enrich the user experience by adding value to the discussion surrounding the anchor content. These examples are used to train the dialogue classifier.

In an embodiment, retrieval augmented generation (RAG) is used to enhance the process of generating completions by incorporating additional context into the set of large language model prompts. RAG involves the use of a retrieval system that fetches relevant information from a database, or a corpus of texts based on the input prompt before the large language model generates its completion. This additional step allows the LLM to access a broader range of information and context that might not be present in its pre-trained knowledge base or directly inferred from the prompt alone.

For instance, if the anchor content item is an article about a recent technological advancement, the retrieval system could pull up related articles, research papers, or forum discussions on the topic. These retrieved texts would then inform the LLM's generation process, enabling it to produce completions that are not only relevant but also deeply informed by the latest information and diverse viewpoints on the subject. This could lead to the creation of engagement content items that are more insightful, topical, and nuanced, thereby enriching the dialogue examples used for training the dialogue classifier.

The benefits of integrating RAG into are several. Firstly, it enhances the quality and relevance of the generated completions by grounding them in a wider context, making them more informative and engaging for users. Secondly, it broadens the scope of dialogue examples available for training the classifier, contributing to a more robust and versatile model capable of handling a greater variety of dialogues. Finally, by leveraging the most current and comprehensive information, the approach ensures that the dialogue classifier is trained on data that reflects the latest trends and discussions, keeping the platform's content fresh and relevant. Overall, the use of RAG to augment the generation process can improve the effectiveness of the system and method 100 in creating and curating engaging dialogue content.

Training 115 a dialogue classifier involves developing an AI model capable of understanding and evaluating the quality of interactions between users and content within a multi-user application system. This process starts with assembling a set of dialogue examples, each consisting of a pair formed by an anchor content item (such as a social media or professional network post) and its corresponding engagement content item (like a comment or reply) generated in the previous steps of the system and method 100. These examples serve as training data, providing the classifier with a diverse range of interactions to learn from, including various topics, tones, and types of engagement.

A “dialogue” may be defined as a pair comprising an anchor content item and an engagement content item. The anchor content item serves as the initial piece of content, which could be a post, article, or any subject matter prompting discussion or interaction. The engagement content item, on the other hand, includes responses or reactions to the anchor content or another engagement content item, such as comments, replies to comments, or any form of user-generated content that engages with the initial anchor content item or an engagement content item that engages with the initial anchor content item. This structure is designed to mimic real-life interactions on digital platforms, where conversations unfold as a series of exchanges between different users. For instance, in an online forum, the anchor content item might be a user's post asking for advice on a specific topic, and the engagement content items would then be the various responses and follow-up comments from other users, each adding their perspective, advice, or further questions. By pairing an anchor content item with one or more engagement content items, the techniques capture the dynamic and interactive nature of conversations online. This pairing is useful for training the dialogue classifier, as it allows the model to learn from real-world examples of how conversations evolve and how users engage with content and with each other, ultimately enhancing the classifier's ability to evaluate and score dialogues based on their relevance, engagement potential, or quality.

The training process adjusts the classifier's parameters to minimize the difference between its predictions and the actual outcomes, effectively teaching it to recognize patterns that denote high-quality dialogues. This could involve identifying characteristics of engagement that are insightful, relevant, constructive, or particularly engaging based on the context provided by the anchor content item. Through this training, the classifier becomes adept at scoring dialogues, with higher scores likely assigned to interactions that are expected to foster a more vibrant and engaging user experience.

The outcome is a trained dialogue classifier that can evaluate new sets of dialogues—comprising unseen anchor content and potential engagement responses—by assigning scores that reflect their perceived quality or relevance. This trained classifier is useful in automating the selection of engagement content that is most likely to enrich user interactions and enhance the overall engagement within the platform.

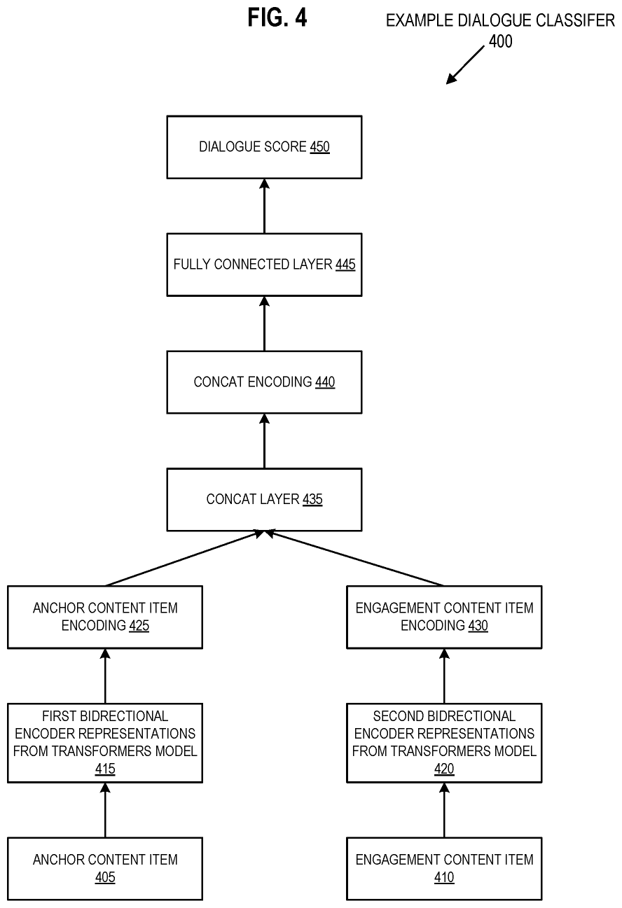

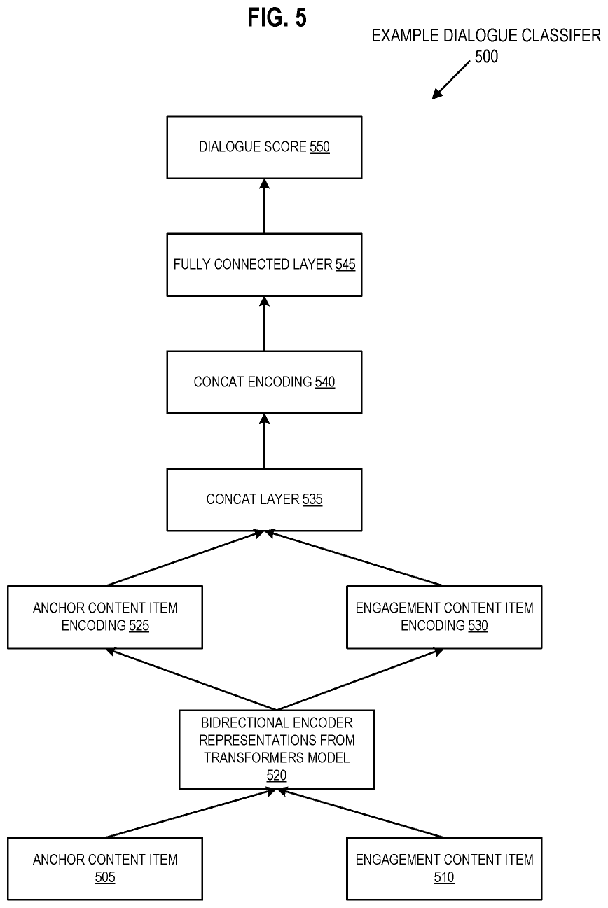

The dialogue classifier is designed to assess and score dialogues based on their relevance and quality of engagement. Suitable machine learning models for this dialogue classifier encompass a range of advanced neural network architectures known for their efficacy in natural language processing (NLP) tasks. Models such as Bidirectional Encoder Representations from Transformers (BERT), Generative Pre-trained Transformer 3 (GPT-3), and their derivatives are well-suited for this role due to their deep understanding of language context, nuance, and the ability to handle varied dialogue scenarios. Example architectures of the dialogue classifier are described below with respect to FIG. 4 and FIG. 5.

BERT, with its bidirectional training, is particularly adept at understanding the context of a word based on all its surroundings, making it ideal for evaluating the relevance and quality of engagement content in relation to anchor content. GPT-3, known for its generative capabilities, can also be fine-tuned to classify dialogues based on the nuances of human interaction, thereby determining the engagement quality.

Furthermore, Recurrent Neural Networks (RNNs) and their more advanced versions like Long Short-Term Memory (LSTM) networks or Gated Recurrent Units (GRUs) could also be employed, especially for their proficiency in handling sequences of data, which is inherent in dialogues. These models can learn patterns in the sequence of interaction between the anchor content and engagement content, providing valuable insights into the dialogue's quality.

Combining multiple models to leverage their individual strengths can also be an effective strategy. An ensemble might include a mix of LSTM, CNN (Convolutional Neural Networks), and transformer-based models to achieve a more robust and accurate classification of dialogues.

Depending on the dataset's size and quality, traditional supervised learning models such as Support Vector Machines (SVMs) or Gradient Boosting Machines (GBMs) could also be employed for dialogue classification. These models might be more suitable for scenarios with well-defined feature sets and when computational resources are a limiting factor.

The choice of model can depend on the specific requirements of the implementation at hand, such as the need for understanding complex language structures, handling large datasets, and the computational resources available. Utilizing a model that can accurately interpret and score the dialogues facilitates the selection of the most engaging and relevant content to highlight within the multi-user application system.

The step of using 120 the trained dialogue classifier to determine a respective dialogue score for each dialogue in a set involves evaluating the quality and relevance of interactions between anchor content items (such as social media posts) and engagement content items (such as comments). Once the dialogue classifier has been trained on a dataset comprising examples of these interactions, it gains the ability to analyze new dialogues—that is, new combinations of posts and responses—based on the learned patterns of what constitutes engaging and relevant content.

The dialogue score quantifies (e.g., as a numerical value between 0 and 1, 1 and 10, or 1 and 100, etc.) the engagement level, relevance, or quality of each interaction, allowing the system to rank or prioritize dialogues according to their perceived value to users. This scoring process is useful for identifying which engagement content items are most likely to contribute positively to the user experience by fostering meaningful interaction, sparking further conversation, or providing insightful commentary related to the anchor content.

To accomplish this, each dialogue (anchor content paired with its engagement content) is input into the classifier, which then applies its learned model to assess the dialogue's characteristics-such as the relevance of the response to the post, the sentiment expressed, and the potential to engage other users. The output is a dialogue score that reflects the classifier's assessment of the engagement quality of that particular interaction. This score is then used to guide the selection of engagement content items to be highlighted within the application, with higher-scoring dialogues being given prominence to enhance user engagement and interaction within the platform.

The step of selecting 125 an engagement content item of a particular dialogue from the set of dialogues based on the respective dialogue score is a useful mechanism for promoting quality interactions within the multi-user application system. After the dialogue classifier has evaluated each dialogue—comprising an anchor content item and its associated engagement content items—and assigned a dialogue score reflecting the interaction's quality, relevance, or potential to engage, this step involves leveraging those scores to make informed decisions about which engagement content items to highlight. Specifically, the system reviews the dialogue scores and identifies those engagement content items associated with particularly high-scoring dialogues. These selected items are presumed to represent the most meaningful, insightful, or engaging responses to the anchor content items, making them prime candidates for increased visibility within the platform. By prioritizing content that has been algorithmically determined to enhance the user experience, this step ensures that users are more likely to encounter and engage with high-quality content, thereby fostering a richer and more engaging community dialogue.

In an embodiment, the selection 125 of the engagement content item is from among a set of dialogues that all pertain to the same anchor content item. For instance, this can manifest in the selection of a particular comment of a set of comments that all respond to the same social media post. By concentrating on dialogues associated with a singular anchor content item, the system can delve deeply into the nuances of user interactions and opinions related to that content. This approach enables the identification and highlighting of the most engaging, insightful, or relevant engagement comment item from a potentially vast pool of engagement content items engaging with a particular anchor content item.

The dialogue classifier, trained on examples of anchor content items paired with their engagement content items, evaluates each dialogue—e.g., each comment in relation to a particular post—assigning scores that reflect the perceived quality or relevance of the interaction. Selecting the highest-scoring dialogue for the same anchor content item allows the platform to showcase a particular perspective, insightful, or clarifying engagement content item that enriches the anchor content item. This not only serves to highlight insightful user contributions that may otherwise remain buried in the volume of responses but also stimulates further discussion and engagement, potentially drawing more users into the conversation. This embodiment enhances the depth and quality of discourse surrounding individual pieces of content, leveraging the collective insight and engagement of the community to foster a richer, more interactive user experience.

In an embodiment, a safeguard mechanism is incorporated where no engagement content item is selected for a given anchor content item if none of the dialogues in the set achieves a dialogue score that surpasses a predefined minimum threshold. This threshold is essentially a quality control measure, ensuring that only content deemed sufficiently engaging, insightful, or relevant is highlighted within the multi-user application system's interface. The dialogue classifier, trained to assess the potential engagement value of interactions between anchor content items and their respective engagement content items, assigns scores to each dialogue. If all the dialogues associated with a particular anchor content item fall short of the minimum score, it indicates that none of the generated engagement content meets the platform's standards for promoting interaction or adding value to the user experience.

This cautious approach prevents the promotion of low-quality or marginally relevant content, maintaining a high standard of discourse on the platform. It reflects an understanding that it is better to forego highlighting any engagement content than to compromise on content quality, as subpar interactions could detract from the user experience and diminish the perceived value of the platform's content. By setting such a threshold, the system ensures that highlighted content not only fosters meaningful engagement but also upholds the integrity and utility of the platform, encouraging users to participate in discussions that are genuinely enriching and reflective of the community's interests and standards.

The step 130 of the method 100 involves taking the engagement content item selected for a particular dialogue—based on its high dialogue score—and ensuring that it is prominently displayed within the graphical user interface of the multi-user application system. This action is useful for elevating the visibility of high-quality interactions that are deemed to significantly enhance user engagement. By highlighting these selected engagement content items, the system actively directs user attention to content that is likely to be more engaging, insightful, or relevant. This could manifest in various forms within the interface, such as a highlighted comment within a social media feed, a featured response in a discussion forum, or a prioritized message in a notification area. The intention is to make these pieces of content more accessible and noticeable to users, thereby increasing the likelihood of further interaction, such as likes, shares, comments, or even sparking new discussions. This strategic presentation supports the overarching goal of fostering a vibrant and engaging user community by leveraging the capabilities of artificial intelligence (AI) to curate and promote content that resonates with the audience.

In the context of method 100, when multiple anchor content items, such as posts, are displayed within the graphical user interface of the multi-user application system, the system and method 100 allows for selective highlighting of engagement content items for only some of these displayed anchor content items. This selective approach is based on the dialogue scores assigned by the trained dialogue classifier, which evaluates the quality and relevance of interactions (dialogues) between anchor content items and their respective engagement content items. In practice, this means that within a user's feed featuring multiple posts, a comment might be highlighted as an engagement content item only for those posts where the associated dialogue has achieved a score that exceeds a certain threshold, indicating a high level of engagement or relevance.

This selective highlighting strategy ensures that users are presented with the most engaging and relevant content, enhancing their experience by drawing attention to interactions that are likely to be of interest or add value to their understanding of the topic at hand. It prevents the interface from becoming cluttered with highlighted content of variable quality, focusing user attention on the highlights that truly matter. For instance, in a feed with ten posts, only one might have a comment highlighted because the dialogue around that post was deemed particularly insightful or engaging according to the system's criteria. This approach optimizes the user's engagement with the platform, encouraging deeper interaction with content that has been vetted for quality and relevance, thereby fostering a more meaningful and satisfying user experience.

In the context of system and method 100, the concept of engagement content items and anchor content items can extend beyond just comments on social media posts, embracing a wide variety of content types across different multi-user application systems.

Some examples of possible anchor content items include any or all of: blog posts such as in platforms focused on written content, a blog post serves as a substantial piece of content around which discussions and engagements can form; videos such as in on video-sharing platforms, each video acts as an anchor content item, inviting viewers to engage through comments, likes, and shares; images or photo albums such as in image-sharing applications or social networks, photographs or curated image collections serve as the focal point for user reactions and discussions; news Articles such as on news aggregation or discussion platforms, each article can be an anchor for users to engage with by providing opinions, analyses, or additional information; questions such as in Q&A platforms, a user-posed question serves as the anchor, with the engagement being the variety of answers and discussions it generates; product listings such as on e-commerce sites, each product page can be considered an anchor content item, with reviews, ratings, and questions about the product serving as engagement content, or any other suitable type of anchor content item.

Some examples of possible engagement content items include any or all of: replies or responses beyond comments that direct replies to specific comments or responses in a threaded discussion format offer a more granular level of engagement; ratings or reviews for products, services, or content, user-generated ratings and written reviews provide valuable feedback and engage other users; shares or reposts of an anchor content item to a different part of the platform or to another platform altogether can be a form of engagement, spreading the content's reach; upvotes/downvotes on platforms that allow content to be voted on, these votes are a form of engagement, signaling the community's approval or disapproval; tags or mentions where users can engage with content by tagging other users or mentioning them in comments, thereby expanding the conversation; edits or contributions in collaborative platforms, such as wikis, edits or contributions to an existing piece of content represent a significant form of engagement, directly altering or adding to the anchor content; or any other suitable type of engagement content item.

### Example Large Language Model Prompt

FIG. 2 illustrates an example large language model prompt 200 for high-quality engagement content item unrolling. Prompt 200 (or one like it) may be input to a LLM to generate one or more positive examples of an engagement content item (e.g., a comment) that provides insight on a given anchor content item (e.g., social media or professional networking post). The line numbers (e.g., “01:”, “02:”, “03:” etc.) are provided for references purposes only in this detailed description and are not considered part of the prompt 200.

At Lines 01-06, the prompt 200 includes general instructions for the LLM to generate a number (in this example, 3) of diverse and insightful comments that reflect different perspectives on a post that is included later the prompt 200 at Lines 34-47 where the post pertains to a social media platform for professionals to discuss their work. By specifying the need for varied styles, language, and sentence structure, the prompt 200 ensures that the generated comments mimic the diversity of real-world professional discussions. These comments can then serve as example engagement content items for training the dialogue classifier.

In the provided example, the prompt 200 specifically requests the generation of three comments in response to a post on a professional social media platform, aiming to simulate a varied and nuanced conversation around the topic of the post. However, it is important to note that the number of comments requested by such a prompt is flexible and can be adjusted to meet different objectives or requirements of the multi-user application system. Depending on the context, the prompt 200 could be tailored to request more or fewer comments. For instance, if the goal is to generate a broad spectrum of perspectives or to simulate a highly engaged discussion, the prompt 200 might ask for a larger number of comments, say five or ten. Conversely, if the objective is to focus on a few high-quality, in-depth responses that delve deeply into specific aspects of the anchor content, the prompt 200 might request only one or two comments.

In scenarios where the desired number of comments for a post exceeds the capacity of a single prompt due to limitations in prompt length, complexity, or the large language model's (LLM) processing constraints, the method allows for the generation and submission of multiple prompts for the same post. This approach effectively divides the task into smaller, manageable segments, each prompt requesting a portion of the total desired comments. By doing so, it ensures that the system can still achieve the required volume of engagement content without compromising the quality or diversity of the generated responses. For instance, if the objective is to generate ten comments for a detailed discussion on a professional social media platform but the LLM or the system's design constraints limit each prompt to handling only up to five comments at a time, two separate prompts can be crafted and submitted sequentially or in parallel. Each of these prompts would be tailored to generate a subset of the total comments, ensuring that across all prompts, a wide range of perspectives and styles is covered.

While the example prompt 200 is specifically designed for generating comments on posts within a professional social media platform, the methodology it illustrates is highly adaptable and can be applied across a wide range of contexts and content types within various multi-user application platforms. This means that prompts can be customized not only to generate comments but also other forms of engagement content items, such as reviews for products on e-commerce sites, answers to questions on Q&A platforms, or even creative responses like stories or artwork in community forums. Similarly, the nature of the anchor content item can vary significantly from one platform to another, extending beyond social media posts to include articles, videos, product listings, or discussion threads. The flexibility of the prompt design allows it to cater to the specific interaction dynamics and content formats of different platforms, enabling the generation of engagement content that is contextually relevant and tailored to the unique user communities and content ecosystems of each platform.

At Lines 08-24, the example prompt 200 provides three engagement content item specifications for the three comments that the prompt 200 requests to generate. Each specification specifies one or more features of the corresponding engagement content item to be generated. Various categories of features are possible. Each category may encompass several features in the category. In an embodiment, the feature categories include any or all of: the length of the engagement content item; whether the engagement content item is to comment on a particular point made by the author of the anchor content item, or instead comment on the overall topic of the anchor content item; whether the engagement content item is to have a social interaction with the author of the anchor content item; the depth type of the engagement content item; the tone of the engagement content item; and any other suitable feature category.

The length of the engagement content item can be specified in the prompt in various different ways such as a number of characters, words, sentences, or paragraphs.

Whether the engagement content item is to comment on a particular point made by the author of the anchor content item or instead comment on the overall topic of the anchor content item can be specified in the prompt as a binary or Boolean indication.

Whether the engagement content item is to have a social interaction with the author of the anchor content item can be specified in the prompt as a Boolean indication.

The depth type of the engagement content item can be a selected depth type from a predefined set of depth types. The depth type indicates the way the engagement content item is adds insight to the anchor content item. For example, the manner indicated by the selected depth type could be one of: “[impact]”—the engagement content item is to explore the impact of the point/topic on the relevant wider industry; “[pro-and-cons]”—the engagement content item is to explore the pros and cons of the point/topic; “[how]”—the engagement content item is to explore how things are done in relation to the topic/point; “[why]”—the engagement content item is explore the reasoning behind the point/topic, or how the situation came about; “[advice]”—the engagement content item is to offer actionable advice to professional in the relevant industry related to the post topic; “[disagree]”—the engagement content item is disagree with a point made by the author of the anchor content time and discuss the reason for disagreeing; “[discuss]”—the engagement comment item is to discuss the topic/point in more detail with no particular guidance given; or any other suitable manner.

The tone of the engagement content item can be selected tone from a predefined set of tones. For example, the selected tone can be one of: neutral, excited, enthusiastic, formal, or any other suitable engagement content item tone.

In an embodiment, a single LLM prompt instructs the LLM to generate multiple engagement content items for the same anchor content item using different styles, language (e.g., phrasing and vocabulary), and sentence structure so that the generated engagement content items appear to be written by different people. This can improve output diversity over an approach that uses one LLM prompt per engagement content item, which tends to generate engagement content items with more similar language and sentence structure.

In an embodiment, the LLM prompt is structured to ensure that each generated engagement content item either provides insight into the overall topic of the anchor content item or delves into a specific point made by the author of the anchor content item. This structuring guides the LLM to produce engagement content items that are insightful. It's noteworthy that insightful engagement content items, when authored by humans, sometimes address the overall topic of the anchor content item without directly engaging with the points made by the author. Conversely, other human-authored insightful engagement content items may specifically focus on elaborating or responding to a particular point made by the author of the anchor content item.

The optional DO NOT instructions a Lines 26-30 address some issues with some LLMs. Some or all of these DO NOT instructions may be omitted from a given prompt according to the requirements of the implementation at hand. Some LLM may have an innate idea from training of how an engagement content item is written. For example, unless instructed otherwise, the LLM may regularly generate an engagement content item to include an expression of agreement or disagreement with the author of the anchor content item (e.g., “I couldn't agree more”) or to include a social interaction with the author (e.g., “Great point!” or “You are so right”). Further, a LLM may tend to use words and phrases in the prompt (e.g., “author” or “post author”) that are not desired in the generated engagement content items because they are not part of the terminology used by the multi-user application platform. The DO NOT instructions at Lines 26-30 address these issues with these LLMs.

The optional ‘DO NOT’ instructions in Lines 26-30 address some issues encountered with certain LLMs. Depending on the specific requirements of the implementation at hand, some or all of these ‘DO NOT’ instructions may be omitted from a given prompt. Some LLMs may inherently understand from their training how an engagement content item should be written. For instance, unless directed otherwise, an LLM might regularly generate an engagement content item that includes an expression of agreement or disagreement with the author of the anchor content item (e.g., ‘I couldn't agree more’) or includes a social interaction with the author (e.g., ‘Great point!’ or ‘You are so right’). Furthermore, an LLM may tend to use words and phrases from the prompt (e.g., ‘author’ or ‘post author’) that are not desired in the generated engagement content items because they do not align with the terminology used by the multi-user application platform. The ‘DO NOT’ instructions at Lines 26-30 are designed to mitigate these issues.

Utilizing multiple LLM prompts to generate a variety of engagement content items for distinct anchor content items is beneficial for training the dialogue classifier. This approach enriches the training dataset with a wide range of dialogues, encompassing diverse topics, styles, and perspectives. By crafting individual prompts tailored to the specific themes or discussions inherent in each anchor content item, the resulting engagement content items reflect a broad spectrum of potential user interactions. This diversity is instrumental for the dialogue classifier's learning process, as it exposes the model to the complexities and nuances of real-world conversations. The classifier learns to discern the subtleties that make an engagement content item relevant, insightful, or engaging in relation to its anchor content. Moreover, this varied dataset aids the classifier in understanding the dynamics of effective dialogues across different contexts and subjects, enhancing its ability to accurately score and select high-quality engagement content once deployed. The richness of the training data, achieved using multiple prompts, ultimately contributes to a more sophisticated and nuanced dialogue classification system, capable of fostering meaningful interactions and elevating the user experience on the platform.

The anchor content items used as the basis for the LLM prompts can either be actual user-generated content from the multi-user application platform or synthetically generated content. Actual user-generated content includes real posts, comments, questions, or any other form of suitable content created by users of the platform. Utilizing this real content can provide the dialogue classifier with practical, context-rich examples of interactions that reflect genuine user behavior and preferences, offering insights into the types of engagement that occur naturally within the platform's ecosystem.

Alternatively, anchor content items can be synthetically generated, for example, by using a large language model (LLM) itself. By prompting an LLM with specific instructions or themes, synthetic anchor content items can be created that mimic the diversity and complexity of real user-generated content without relying on actual user contributions. This method allows for the creation of a wide range of hypothetical scenarios or discussions that may not yet be extensively represented in the platform's existing content, thereby broadening the scope of the training data. Synthetic generation can be particularly useful for exploring underrepresented topics, generating content in languages or styles that are less common on the platform, or ensuring privacy by avoiding the use of real user data.

Both approaches offer valuable pathways for enriching the training dataset for the dialogue classifier. Actual user-generated content provides authentic examples of user interactions, while synthetically generated content allows for greater control over the diversity and scope of the training examples, potentially covering a wider range of topics and styles. The choice between using actual or synthetically generated anchor content items can be based on the specific needs of the training program, such as the availability of data, privacy considerations, or the desire to simulate a broad spectrum of possible user engagements.

### Example LLM Generated Engagement Content Items

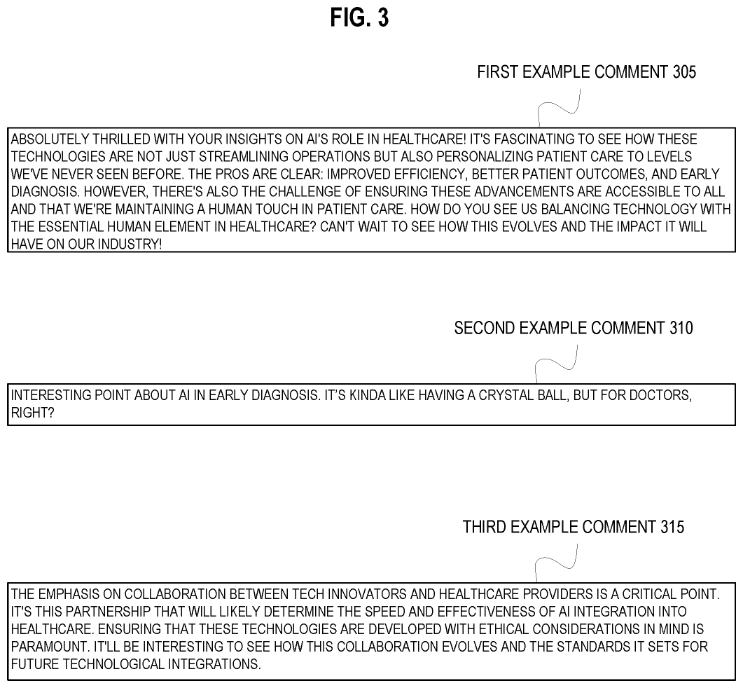

FIG. 3 illustrates examples of large language model generated engagement content items for high-quality engagement content item unrolling. In the example of FIG. 3, the three engagement content items 305, 310, and 315 correspond to those requested by the prompt 200 of FIG. 2.

In particular, as instructed by Lines 8-12 of the prompt 200 of FIG. 2, the first example engagement content item 305 of FIG. 3 is between 5 to 6 sentences in length; has a social interaction with the author of the anchor content item (“Absolutely thrilled with your insights . . . ”); explores the pros and cons of the point/topics (improved efficiency, better patient outcomes, and early diagnosis versus accessibility and maintaining human touch); and has an enthusiastic tone.

As instructed by Lines 14-19 of the prompt 200 of FIG. 2, the second example engagement content item 310 of FIG. 3 is 1-2 sentences in length; explores how things are done in relation to the topic/point (like having a crystal ball); has a casual tone; and comments on a particular point (early diagnosis) made by the author of the anchor content item.

As instructed by Lines 21-24 of the prompt 200 of FIG. 2, the third example engagement content item 315 of FIG. 3 is 3-4 sentences in length; comments on a particular point (collaboration between tech innovators and healthcare providers) made by the author of the anchor content item; and has a neutral tone.

### Example Dialogue Classifier Architectures

FIG. 4 illustrates an example architecture 400 of a dialog classifier for high-quality engagement content item unrolling encompassing two bidirectional encoder representations from transformers models.

The example dialogue classifier 400 incorporates two trained Bidirectional Encoder Representations from Transformers (BERT) models 415 and 420, along with a trained fully connected layer 445, to evaluate the interactions between anchor content items and engagement content items. The process begins with each of the BERT models processing one part of the dialogue pair: one model 420 handles the engagement content item 410, and the other model 415 processes the anchor content item 405. These items 405 and 410 are input separately into their respective BERT models 415 and 420, where they are analyzed and encoded into high-dimensional vector representations 425 and 430. These representations capture the semantic and contextual nuances of both the anchor and engagement content items 405 and 410, effectively summarizing their content in a form that a machine learning system can understand and compare.

Following this, the encoded representations 425 of both the anchor and engagement content items 405 and 410 are combined and fed into the trained fully connected layer 445. This layer acts as the integrative component of the classifier 400, synthesizing the information from both content items 405 and 410 to assess the quality of the dialogue. It evaluates how well the engagement content item 410 relates to, complements, or adds value to the anchor content item 405, based on the learned patterns and criteria during the classifier 400's training phase.

The output of this comprehensive analysis is a dialogue score 450 that quantitatively reflects the relevance, engagement potential, or quality of the interaction between the anchor and engagement content items 405 and 410. This score 450 is used to rank or prioritize dialogues, enabling the system to select the most valuable engagement content items for highlighting within the user interface.

The example dialogue classifier 400 employs two separate Bidirectional Encoder Representations from Transformers (BERT) models 415 and 420 to process the anchor and engagement content items individually, generating encoded representations for each. To synthesize these distinct representations into a unified form that can be evaluated for dialogue quality, a concatenation (concat) layer 435 is used. This concat layer 435 takes the output encodings from both BERT models—one encoding 425 representing the anchor content item 405 and the other encoding 430 representing the engagement content item 410—and merges them into a single, comprehensive encoding 440. This combined encoding 440, or concat encoding 440, effectively captures the essence of both the anchor and engagement content items 405 and 410 within a single data structure, preserving the contextual and semantic nuances of each while enabling a holistic analysis of the dialogue.

The concat encoding 440 then serves as the input to the fully connected layer 445, which is the next step in the classifier 400's architecture. The fully connected layer 445 utilizes this detailed, composite representation to perform a more nuanced analysis, assessing the interaction between the anchor and engagement content items based on the integrated information. By combining the encodings in this way, the classifier 400 can consider the relationship between the content items, evaluating how well the engagement content 410 complements or adds to the discussion initiated by the anchor content 405.

The concat layer 435 merges the encoded representations 425 and 430 of the anchor and engagement content items 405 and 410, produced by their respective Bidirectional Encoder Representations from Transformers (BERT) models 415 and 420, into a single concat encoding 440. There are several methods by which the concat layer 435 can combine these representations to achieve a holistic understanding of the dialogue. One straightforward approach is simple concatenation, where the layer 435 directly appends the engagement content item 410's encoding vector 430 to the anchor content item 405's encoding vector 425, creating a longer, unified vector that retains the information from both sources.

Another method involves element-wise operations, such as addition, multiplication, or averaging, which blend the values of corresponding elements in the two encoding vectors 425 and 430 to produce a new vector 440 that represents an integrated form of both items. This method can help highlight the interactions between the two items' encodings, potentially capturing synergies or disparities between the content items 405 and 410.

A more complex approach might involve applying a transformation to the concatenated vectors, such as through a neural network layer within the concat layer 435 itself, which learns the most effective way to integrate the information from the two encodings 425 and 430. This could involve learning weights to apply to different parts of the concatenated vector, effectively prioritizing certain aspects of the anchor or engagement content in the combined representation 440.

Additionally, the concat layer 435 could employ attention mechanisms, which allow the model to focus on specific parts of the encoding vectors 425 and 430 that are most relevant for assessing the dialogue's quality. This method dynamically adjusts the importance of different segments of the anchor and engagement encodings 425 and 430 based on the context they provide to each other.

Each of these methods has its advantages, and the choice among them would depend on the specific goals of the dialogue classification system, the nature of the content being analyzed, and the desired balance between capturing detailed information and maintaining computational efficiency. The aim of using these concat layer 435 techniques is to produce a concat encoding 440 that effectively encapsulates the relationship between the anchor and engagement content items 405 and 410, enabling the fully connected layer 445 to make nuanced assessments of dialogue quality.

The training of the dialogue classifier 400 involves a process to accurately assess dialogues. Initially, the system requires a dataset of dialogue examples, each consisting of an anchor content item and an associated engagement content item, along with labels numerically indicating the quality or relevance of the dialogue, such as whether it's insightful, relevant, or engaging. These labels could be determined based on user interactions, expert annotations, or predefined criteria that reflect the desired engagement outcomes.

In an embodiment, where the dialogue classifier 400 is trained to assess the quality of interactions between anchor content items and engagement content items, the labels assigned to dialogue examples in the training dataset can take the form of binary labels (e.g., 0 or 1) or values within a range, each format serving to represent the level of insightfulness of the engagement content item relative to the anchor content item of the dialogue example. Binary labels simplify the classification into two distinct categories, such as ‘insightful’ (e.g., 1) or ‘not insightful’ (e.g., 0), allowing the classifier 400 to focus on distinguishing between engagement content that significantly contributes to the discussion and content that does not. This binary approach is effective for applications where the primary interest is in identifying content that meets a minimum threshold of relevance or quality.

Alternatively, labels can be assigned as values within a range (e.g., between [0, 1], [0,1), (0, 1], or (0, 1)), offering a more nuanced representation of insightfulness. This method acknowledges that the contribution of engagement content to a dialogue exists on a spectrum, from highly insightful to minimally relevant. Labels within a range allow the classifier 400 to learn to not only recognize the presence of insight but also to evaluate the degree of insightfulness, providing a more detailed assessment of the engagement content's value. This granular approach is useful in applications where it's beneficial to differentiate between levels of contribution, enabling more sophisticated content curation strategies that can enhance user experience by prioritizing content that offers the greatest depth of insight.

During training, each dialogue example is processed in two parts: the anchor content item 405 is input into one BERT model 415, and the engagement content item 410 is input into the other 420. Each model 415 and 420 encodes its respective content item 405 and 410 into a high-dimensional vector representation 425 and 430, capturing the semantic and contextual nuances of the text. These encodings 425 and 430 are then combined through a concat layer 435, forming a unified representation 440 that integrates the information from both the anchor and engagement content items 405 and 410.

This concatenated encoding 440 serves as the input to the fully connected layer 445, which is tasked with making a prediction about the dialogue's quality based on the combined representation 440. The system's predictions are compared against the actual labels in the training dataset, and discrepancies between the predicted and true labels are used to adjust the dialogue classifier 400's parameters through backpropagation. This iterative process of prediction, comparison, and adjustment continues across multiple epochs, gradually refining the dialogue classifier 400's weights and biases to minimize prediction errors.

In an embodiment, the two BERT models 4115 and 420, the concat layer 435, and the fully connected layer 445 are jointly trained. During the joint training process, the entire system—from the individual BERT models 415 and 420 through the concat layer 435 to the fully connected layer 445—is treated as a cohesive unit. The goal is to minimize the difference between the system's predictions and the actual quality labels of the dialogue examples in the training dataset. This is typically achieved through backpropagation, where errors in the dialogue score predictions are used to adjust not only the weights of the fully connected layer 445 but also the parameters within the concat layer 435 and both BERT models 415 and 20. By adjusting these parameters simultaneously, the system learns to optimize the encoding process for both content items 405 and 410 and the manner in which these encodings are integrated and assessed for dialogue quality.

FIG. 5 illustrates an example architecture 500 of a dialog classifier for high-quality engagement content item unrolling encompassing one bidirectional encoder representations from transformers model. Dialogue classifier 500 is like dialogue classifier 400 of FIG. 4 in that it a dialogue score is generated by a fully connected layer 545 which operates on a concat encoding 540 produced by a concat layer 535. The concat layer 535 generates the concat encoding 540 from an anchor content item encoding 525 of an input anchor content item 505 and an engagement contact item encoding 530 of an engagement content item 510 paired with the input anchor content item 505.

However, the dialogue classifier 500 includes a single BERT model 520 along with the fully connected layer 545. Unlike the dual-BERT model setup of the dialogue classifier 400 of FIG. 4 where each content type (anchor and engagement) is processed by its own dedicated BERT model, both the engagement content item and the anchor content item of a particular dialogue are input separately but into the same BERT model 520 in the dialogue classifier 500.

This approach allows the single BERT model 520 to analyze and encode each content item 505 and 510 individually, creating separate high-dimensional vector representations 525 and 530 for both the engagement content item 510 and the anchor content item 505. These separate encodings 525 and 530 capture the semantic nuances and contextual relevance of each content item 505 and 510, maintaining a clear distinction between the two during the initial processing stage. Following this, the method involves combining these separate encodings 525 and 530 in a manner that allows for their integration, which may be handled by subsequent processing steps or directly within the fully connected layer 545.

The fully connected layer 545 then interprets these combined or sequentially processed representations to determine the dialogue score 550, which quantitatively reflects the interaction's relevance, quality, or engagement level between the anchor and engagement content items 505 and 510.

By employing a single BERT model 520 for separate inputs, the dialogue classifier 500 optimizes resource use while still capturing detailed insights into the interaction dynamics between the anchor and engagement content items.

### Example Graphical User Interfaces

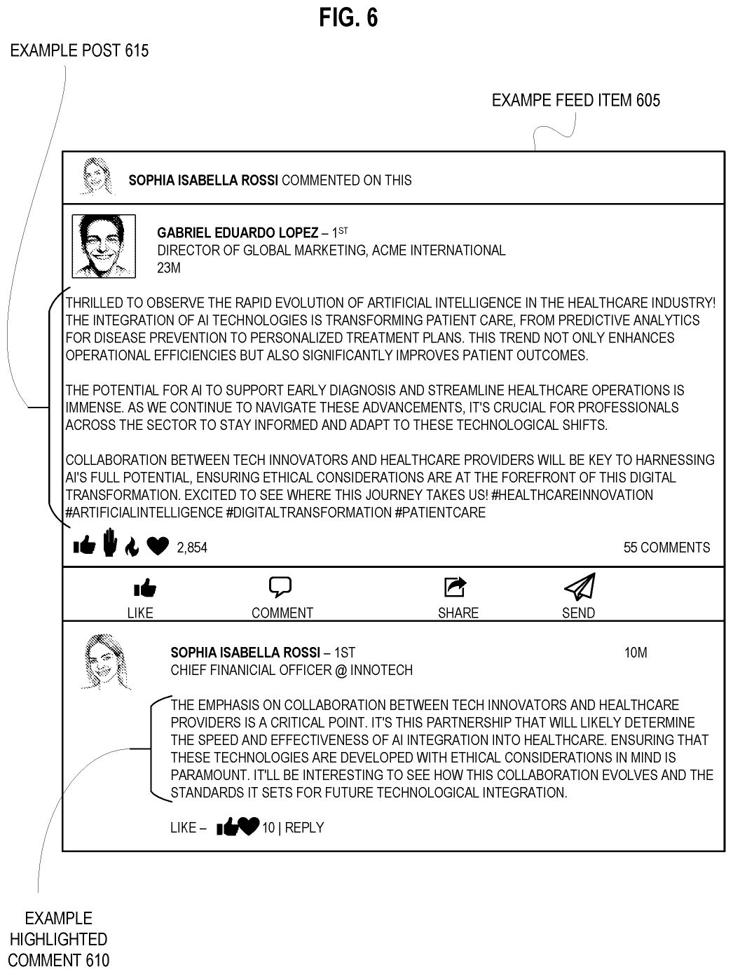

FIG. 6 illustrates an example feed item 605 graphical user interface for high-quality engagement content item unrolling presenting an example highlighted engagement content item.

FIG. 6 depicts a scenario within a social media or professional networking platform where the graphical user interface includes a user's feed. This feed is composed of various feed items, including posts from individuals the user follows, advertisements, and potentially recommended content. Among these items, there's a specific post 615—an anchor content item—that has attracted engagement in the form of comments from other users. Utilizing the techniques disclosed herein, the platform employs a dialogue classifier, trained on examples of posts and their corresponding comments, to evaluate the quality and relevance of each comment in relation to the original post 615. A particular comment 610 that stands out for its insightfulness, relevance, or contribution to the discussion is scored highly by the classifier. As a result, this comment 610 is selected to be highlighted alongside the post within the user's feed. When the user scrolls through their feed, they encounter this feed item 605 where not only is the original post 615 displayed, but the selected comment 610 is also prominently featured, possibly under a “Highlighted Comment” section, drawing attention to engaging discussions and enriching the user's experience on the platform. This approach ensures that valuable interactions receive the visibility they deserve, thereby encouraging a more vibrant and engaging community dialogue.

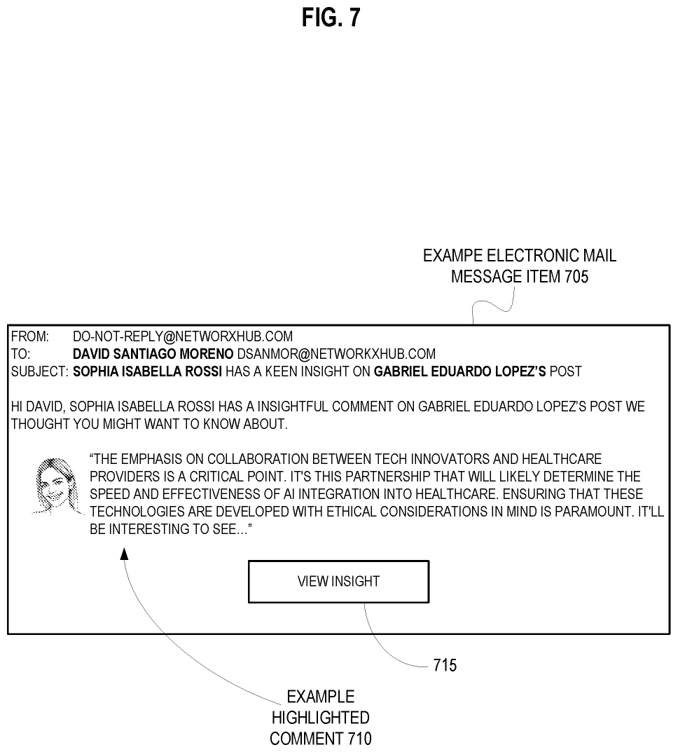

FIG. 7 illustrates an example electronic mail message item 705 graphical user interface classifier for high-quality engagement content item unrolling presenting an example highlighted engagement content item.

FIG. 7 illustrates an effective application of the disclosed techniques that can extend beyond the immediate boundaries of the social media or professional networking platform to engage users through personalized email communications. The platform may implement the disclosed techniques to evaluate interactions on posts. A user may receive an email notification 705 from the platform, which has been triggered by the identification of an insightful comment 710 on a post that the user had previously shown interest in, either by commenting, liking, or simply spending time viewing. This email message 705 is designed with the user experience in mind, containing not only a brief preview of the insightful comment 710 but also graphical user interface controls 715, such as a “View Insight” button or link. When the user interacts with these controls 715, they may be navigated back to the platform, directly to the location of the insightful comment 715 within the context of the original post. This targeted notification is the result of the platform's dialogue classifier, trained according to the techniques disclosed herein, scoring this comment 710 highly for its insightfulness or relevance. The decision to send this email to the user is based on the classifier's assessment, aiming to enhance user engagement by drawing attention to high-quality content that may interest them, thereby enriching their overall experience with the platform and encouraging further interaction within the community.

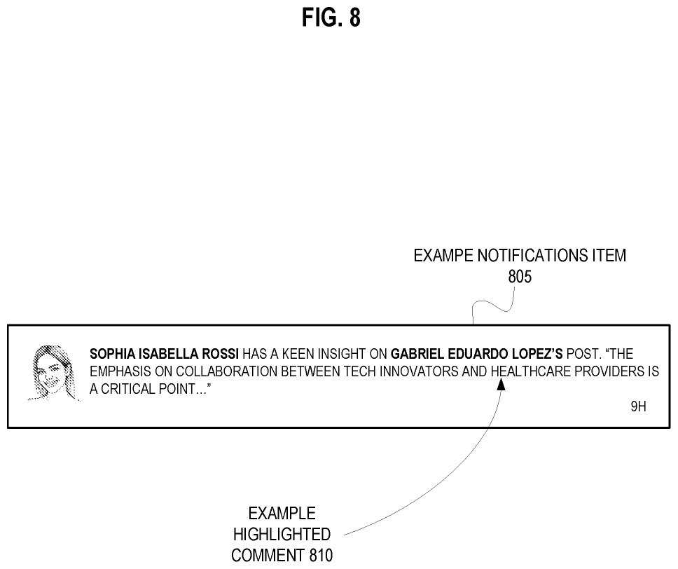

FIG. 8 illustrates an example notifications item 805 graphical user interface classifier for high-quality engagement content item unrolling presenting an example highlighted engagement content item.

FIG. 8 illustrates an application that enhances user engagement through targeted notifications or alerts within the graphical user interface of a social media or professional networking platform. For instance, a user could receive a notification 805 within a dedicated banner or a list that is part of the platform's interface. This notification 805 is designed to inform the user about an insightful comment 810 made on one of their or another user's posts. The example notification item 805 doesn't just signal the existence of comment 810 but also includes a snippet or portion of the insightful comment 810 itself, giving the user a preview of the insight provided. This mechanism ensures that the content highlighted is not only relevant but also of substantial value to the conversation sparked by the original post.

The process leading to the generation of this notification 805 involves the dialogue classifier outlined, which evaluates engagements across the platform using a trained model to score dialogues for their relevance and insightfulness. The classifier's scoring of this specific comment 810 as highly insightful triggers the notification mechanism, selecting this engagement as noteworthy. Consequently, the platform decides to notify the user, aiming to draw their attention back to the conversation on their post and encourage further interaction. This targeted approach, informed by the method's ability to discern, and elevate meaningful content, enriches the user experience by making them aware of valuable contributions to their discussions and fostering a deeper engagement with the platform's community.

In an embodiment, the notification item is interactive such that the user can interact with the item 805 (e.g., click on it or otherwise select it) to navigate to directly to the location of the insightful comment 810 within the context of the original post like the “View Insight” controls 715 of FIG. 7.

### Example Multi-User Application System

FIG. 9 illustrates an example multi-user application system 900 in which the techniques disclosed herein for high-quality engagement content item unrolling are implemented. Example multi-user application system 900 is implemented at least in part by one or more programmable electronic devices (e.g., example programmable electronic device 1000 of FIG. 1000) located or housed in one or more data centers or other physical computer hosting facilities. Example multi-user application system 900 is connected to a data communications network, such as the internet, to interact with (e.g., exchange data with) the programmable electronic devices of users.

Example multi-user application system 900 is an online service, platform, or site that focuses on facilitating the building of social, professional, organizational, community, or governmental networks or relations among people, business, organizations, governments, communities, groups, or other entities (generally “members”). Example multi-user application system 900 allows members to connect with other members based on shared interests, backgrounds, real-life connections, or activities. Members create personal profiles where they post various types of content, such as text, photos, and videos, and engage with others through features like messaging, commenting, and liking.

Example multi-user application system 900 offers a digital space for members to share their experiences, ideas, and thoughts, fostering communication and interaction across diverse communities. In an embodiment, example multi-user application system 900 offers additional functionalities, such as creating groups, organizing events, and discovering content based on member preferences.

Example multi-user application system 900 is composed of various modules and components, each serving a distinct function to enhance member experience and interaction. One module of example multi-user application system 900 is the high-quality engagement content item unrolling module 902 configured to perform or implement the techniques disclosed herein for high-quality engagement content item unrolling. In addition to high-quality engagement content item unrolling module 902, example multi-user application system 900 includes any or all of the following modules: member profile module 904, content sharing module 906, messaging and communication module 908, notification system 910, groups and events module 912, privacy and security settings module 914, or any other suitable multi-user application system module.

Member profile module 904 allows members to create and manage their personal profiles, providing information about themselves and their interests. The member profile module 904 provides a personal space for members to represent themselves and manage their presence on the platform. This member profile module 904 allows members to create and customize their profiles, which act as their digital identity within the network. In an embodiment, the customization includes adding personal information such as name, profile picture, cover photo, logo, avatar, or a bio that reflects their identity, personality, or interests. In an embodiment, members also share additional details like their location, education, work history, and interests, helping to paint a more comprehensive picture of who they are.

Besides personal information, the member profile module 904 enables members to showcase their activities and content on the platform. This includes a timeline or feed of their posts, photos, videos, and shared content, providing a chronological overview of their activity. Members manage the visibility of these elements, controlling who can see their posts and personal information through privacy settings integrated within the member profile module 904.

Additionally, the member profile serves as a hub for social interactions. It allows others to view the member's information, connect by sending friend requests or follows, and engage with the member's content through likes, comments, and shares. In an embodiment, member profile module 904 also includes features like badges or indicators of achievements and activities, further enriching the member's profile.

The content sharing module 906 allows members to post, share, and interact with various types of content like text, images, and videos. This content sharing module 906 provides the ability for members to upload different types of media, such as text posts, photos, videos, and links to external content. This content sharing module 906 includes member-friendly interfaces for creating and editing posts, with, in an embodiment, tools for adding filters to photos, editing video clips, or formatting text. Once content is shared, it becomes visible to others within the member's network, depending on the member's privacy settings.

Content sharing module 906 also facilitates interaction with this content, allowing viewers to like, comment, and share posts, thus promoting engagement and discussion. In an embodiment, advanced features include tagging other members, adding location data, or incorporating hashtags to categorize content and increase its visibility. Content sharing module 906 integrates with the system 900's algorithms to display content in members' feeds based on relevance, recency, and personal preferences. In an embodiment, module 906 provided analytics to members, especially content creators or businesses, offering insights into the reach and engagement of their posts.

The messaging and communication module 908 facilitates private and group conversations, enabling direct and instant communication among members. This messaging and communication module 908 offers a range of functionalities that support both private and group messaging. For private messaging, members send and receive text messages, photos, videos, and links in a one-on-one setting, similar to a traditional Short Message Service (SMS) but with enhanced multimedia capabilities. In an embodiment, this private messaging supports features like read receipts, typing indicators, and the ability to send voice messages. In addition to private conversations, the messaging and communication module 908 includes group messaging capabilities, allowing multiple members to communicate in a single thread. This is particularly useful for coordinating events, discussing common interests, or staying connected with a circle of friends or colleagues.

Additionally, the notification system 910 keeps users informed about activities related to their profile, such as new follows, comments, or likes. The notification system 910 keeps members informed and engaged with the platform's activities. This notification system 910 functions by sending alerts to members about various interactions and updates related to their profile or content they are interested in. Notifications are triggered by a range of activities, such as when another member likes or comments on their posts, follows their profile, tags them in a photo, or mentions them in a comment. In an embodiment, notifications include alerts about messages received, event reminders, or updates from groups or pages the member follows.

The functionality of notification system 910 is designed to be both informative and non-intrusive. Members can customize their notification settings, choosing what types of alerts they receive and how they are notified, whether through the platform's interface, email, or mobile push notifications. This customization enhances the member experience by allowing members to stay connected with the aspects of the platform they find most relevant, without being overwhelmed by excessive or irrelevant alerts.

In an embodiment, the notification system 910 incorporates smart algorithms to prioritize and sometimes group notifications based on the member's past interactions and preferences. For instance, a member might receive a summarized notification of all the likes on a post instead of separate alerts for each like. This intelligent handling ensures that members are kept up to date with important interactions and events, helping to increase member engagement and encouraging them to interact more frequently with the platform.

For community building, the groups and events module 912 allows the creation and management of interest-based groups and event organization. The groups and events module 912 allows members to create, join, and interact within focused communities based on shared interests, causes, or activities. In an embodiment, these groups range from public, open to anyone, to private, where membership requires approval. Within a group, members post content, engage in discussions, share resources, and collaborate on projects or initiatives. Groups have their own set of rules and moderators to ensure a constructive and respectful environment. This feature is instrumental in connecting individuals with common interests and facilitating deeper, topic-centered interactions.

The events feature of the groups and events module 912 complement the groups features of module 912 by enabling members to create, share, and manage events. Members set up event pages, where they provide details such as date, time, location, and description. These pages become a hub for inviting attendees, sharing updates, and posting event-related content. The groups and events module 912 includes tools for RSVPs, allowing both organizers and attendees to track who is planning to attend. In an embodiment, events are public or private, and are linked to specific groups or open to the broader network. This feature is particularly valuable for organizing meetups, workshops, conferences, or social gatherings, providing a seamless way to coordinate and communicate with participants.

Together, the groups and events module 912 enhances the social aspect of the networking platform. It encourages members to engage in more meaningful, interest-based interactions and provides tools for organizing and participating in real-world events, thus bridging the gap between online connections and offline activities.

Lastly, the privacy and security settings module 914 is designed to empower members with control over their personal information and interactions on the platform. This privacy and security settings module 914 provides various settings and options that enable members to manage who can view their profile, content, and personal details, as well as who can contact them. Members adjust settings to make their profiles either more public or private, determining the visibility of posts, photos, and friend lists. In an embodiment, members choose to make their content visible to everyone, only to their friends, or to a custom list of specific individuals.

In addition to privacy controls, this privacy and security settings module 914, in an embodiment, includes security features aimed at protecting members' accounts from unauthorized access. In an embodiment, this encompasses options like two-factor authentication, where a member must provide two forms of identification before accessing their account, and alerts for login attempts from unfamiliar devices or locations. In an embodiment, members also report suspicious activity and block or report other members who are harassing or spamming them.

Furthermore, the privacy and security settings module 914 provides tools for members to manage how their data is collected and used by the platform. This includes settings for opting out of certain types of data collection or controlling how their information is used for advertising purposes. By offering these comprehensive privacy and security options, the privacy and security settings module 914 not only safeguards members' personal information and accounts but also enhances their trust and comfort in using the platform, ultimately contributing to a safer and more controlled online environment.

### Example Programmable Electronic Device

FIG. 10 illustrates an example of an example programmable electronic device that processes and manipulates data to perform the techniques disclosed herein for high-quality engagement content item unrolling. Example programmable electronic device 1000 includes electronic components encompassing hardware or hardware and software including processor 1002, memory 1004, auxiliary memory 1006, input device 1008, output device 1010, mass data storage 1012, and network interface 1014, all connected to bus 1016. Network 1022 is connected to, but not part of, example programmable electronic device 1000.

While only one of each type of component is depicted in FIG. 10 for the purpose of providing a clear example, multiple instances of any or all these electronic components are present in example programmable electronic device 1000 in other instances. For example, in an embodiment, multiple processors are connected to bus 1016. Accordingly, unless the context clearly indicates otherwise, reference with respect to FIG. 10 to a component of example programmable electronic device 1000 in the singular such as, for example, processor 1002, is not intended to exclude the plural where, in a particular instance of example programmable electronic device 1000, multiple instances of the electronic component are present. Further, some electronic components might not be present in a particular instance of example programmable electronic device 1000. For example, example programmable electronic device 1000 in a headless configuration such as, for example, when operating as a server racked in a data center, might not include, or be connected to, input device 1008 or output device 1010.

Processor 1002 is an electronic component that processes (e.g., executes, interprets, or otherwise processes) instructions 1018 including instructions 1020 for high-quality engagement content item unrolling. In an embodiment, processor 1002 fetches, decodes, and executes instructions 1018 from memory 1004 and performs arithmetic and logic operations dictated by instructions 1018 and coordinates the activities of other electronic components of example programmable electronic device 1000 in accordance with instructions 1018. In an embodiment, processor 1002 is made using silicon wafers according to a manufacturing process (e.g., 7 nm, 5 nm, or 3 nm). In an embodiment, processor 1002 is configured to understand and execute a set of commands referred to as an instruction set architecture (ISA) (e.g., x86, x86_64, or ARM).

In an embodiment, processor 1002 includes a cache used to store frequently accessed instructions 1018 to speed up processing. In an embodiment, processor 1002 has multiple layers of cache (L1, L2, L3) with varying speeds and sizes.

In an embodiment, processor 1002 is composed of multiple cores where each such core is a processor within processor 1002. The cores allow processor 1002 to process multiple instructions 1018 at once in a parallel processing manner.

In an embodiment, processor 1002 supports multi-threading where each core of processor 1002 handles multiple threads (multiple sequences of instructions) at once to further enhance parallel processing capabilities.

In an embodiment, processor 1002 is any of the following types of central processing units (CPUs): a desktop processor for general computing, gaming, content creation, etc.; a server processor for data centers, enterprise-level applications, cloud services, etc.; a mobile processor for portable computing devices like laptops and tablets for enhanced battery life and thermal management; a workstation processor for intense computational tasks like 3D rendering and simulations; or any other type of CPU suitable for the particular implementation at hand.

While processor 1002 might be a CPU, processor 1002, in an embodiment, is any of the following types of processors: a graphics processing unit (GPU) capable of highly parallel computation allowing for processing of multiple calculations simultaneously and useful for rendering images and videos and for accelerating machine learning computation tasks; a digital signal processor (DSP) designed to process analog signals like audio and video signals into digital form and vice versa, commonly used in audio processing, telecommunications, and digital imaging; specialized hardware for machine learning workloads, especially those involving tensors (multi-dimensional arrays); a field-programmable gate array (FPGA) or other reconfigurable integrated circuit that is customized post-manufacturing for specific applications, such as cryptography, data analytics, and network processing; a neural processing unit (NPU) or other dedicated hardware designed to accelerate neural network and machine learning computations, commonly found in mobile devices and edge computing applications; an image signal processor (ISP) specialized in processing images and videos captured by cameras, adjusting parameters like exposure, white balance, and focus for enhanced image quality; an accelerated processing unit (APU) combing a CPU and a GPU on a single chip to enhance performance and efficiency, especially in consumer electronics like laptops and consoles; a vision processing unit (VPU) dedicated to accelerating machine vision tasks such as image recognition and video processing, typically used in drones, cameras, and autonomous vehicles; a microcontroller unit (MCU) or other integrated processor designed to control electronic devices, containing CPU, memory, and input/output peripherals; an embedded processor for integration into other electronic devices such as washing machines, cars, industrial machines, etc.; a system on a chip (SoC) such as those commonly used in smartphones encompassing a CPU integrated with other components like a graphics processing unit (GPU) and memory on a single chip; or any other type of processor suitable for the particular implementation at hand.

Memory 1004 is an electronic component that stores data and instructions 1018 that processor 1002 processes. In an embodiment, memory 1004 provides the space for the operating system, applications, and data in current use to be quickly reached by processor 1002. In an embodiment, memory 1004 is a random-access memory (RAM) that allows data items to be read or written in substantially the same amount of time irrespective of the physical location of the data items inside memory 1004.

In an embodiment, memory 1004 is a volatile or non-volatile memory. Data stored in a volatile memory is lost when the power is turned off. Data in non-volatile memory remains intact even when the system is turned off. In an embodiment, memory 1004 is Dynamic RAM (DRAM). DRAM such as Single Data Rate RAM (SDRAM) or Double Data Rate RAM (DDRAM) is volatile memory that stores each bit of data in a separate capacitor within an integrated circuit. The capacitors of DRAM leak charge and need to be periodically refreshed to avoid information loss. In an embodiment, memory 1004 is Static RAM (SRAM). SRAM is volatile memory that is typically faster but more expensive than DRAM. SRAM uses multiple transistors for each memory cell but does not need to be periodically refreshed. Additionally, or alternatively, SRAM is used for cache memory in processor 1002 in an embodiment. In an embodiment, memory 1004 encompasses both DRAM and SRAM.

Example programmable electronic device 1000 has auxiliary memory 1006 other than memory 1004. Examples of auxiliary memory 1006 include cache memory, register memory, read-only memory (ROM), secondary storage, virtual memory, memory controller, and graphics memory. In an embodiment, example programmable electronic device 1000 has multiple auxiliary memories including different types of auxiliary memories.

Cache memory is found inside or very close to processor 1002 and is typically faster but smaller than memory 1004. Cache memory is used to hold frequently accessed instructions 1018 (encompassing any associated data) to speed up processing. In an embodiment, cache memory is hierarchical ranging from Level 1 cache memory which is the smallest but fastest cache memory and is typically inside processor 1002 to Level 2 and Level 3 cache memory which are progressively larger and slower cache memories that are inside or outside processor 1002.

Register memory is a small but very fast storage location within processor 1002 designed to hold data temporarily for ongoing operations.

ROM is a non-volatile memory device that is only read, not written to. In an embodiment, ROM is a Programmable ROM (PROM), Erasable PROM (EPROM), or electrically erasable PROM (EEPROM). In an embodiment, ROM stores basic input/output system (BIOS) instructions which help example programmable electronic device 1000 boot up.

Secondary storage is a non-volatile memory. In an embodiment, secondary storage encompasses any or all of: a hard disk drive (HDD) or other magnetic disk drive device; a solid-state drive (SSD) or other NAND-based flash memory device; an optical drive like a CD-ROM drive, a DVD drive, or a Blu-ray drive; or flash memory device such as a USB drive, an SD card, or other flash storage device.

Virtual memory is a portion of a hard drive or an SSD that the operating system uses as if it were memory 1004. When memory 1004 gets filled, less frequently accessed data and instructions 1018 is “swapped” out to the virtual memory. The virtual memory is slower than memory 1004, but it provides the illusion of having a larger memory 1004.

A memory controller manages the flow of data and instructions 1018 to and from memory 1004. The memory controller is located either on the motherboard of example programmable electronic device 1000 or within processor 1002.

Graphics memory is used by a graphics processing unit (GPU) and is specially designed to handle the rendering of images, videos, graphics, or performing machine learning calculations. Examples of graphics memory include graphics double data rate (GDDR) such as GDDR5 and GDDR6.

Input device 1008 is an electronic component that allows users to feed data and control signals into example programmable electronic device 1000. Input device 1008 translates a user's action or the data from the external world into a form that example programmable electronic device 1000 processes. Examples of input device 1008 include a keyboard, a pointing device (e.g., a mouse), a touchpad, a touchscreen, a microphone, a scanner, a webcam, a joystick/game controller, a graphics tablet, a digital camera, a barcode reader, a biometric device, a sensor, and a MIDI instrument.

Output device 1010 is an electronic component that conveys information from example programmable electronic device 1000 to the user or to another device. The information is in the form of text, graphics, audio, video, or other media representation. Examples of output device 1010 include a monitor or display device, a printer device, a speaker device, a headphone device, a projector device, a plotter device, a braille display device, a haptic device, a LED or LCD panel device, a sound card, and a graphics or video card.

Mass data storage 1012 is an electronic component used to store data and instructions 1018. In an embodiment, mass data storage 1012 is non-volatile memory. Examples of mass data storage 1012 include a hard disk drive (HDD), a solid-state drive (SDD), an optical drive, a flash memory device, a magnetic tape drive, a floppy disk, an external drive, or a RAID array device.

In an embodiment, mass data storage 1012 is additionally or alternatively connected to example programmable electronic device 1000 via network 1022. In an embodiment, mass data storage 1012 encompasses a network attached storage (NAS) device, a storage area network (SAN) device, a cloud storage device, or a centralized network filesystem device.

Network interface 1014 (sometimes referred to as a network interface card, NIC, network adapter, or network interface controller) is an electronic component that connects example programmable electronic device 1000 to network 1022. Network interface 1014 functions to facilitate communication between example programmable electronic device 1000 and network 1022. Examples of a network interface 1014 include an ethernet adaptor, a wireless network adaptor, a fiber optic adapter, a token ring adaptor, a USB network adaptor, a Bluetooth adaptor, a modem, a cellular modem or adapter, a powerline adaptor, a coaxial network adaptor, an infrared (IR) adapter, an ISDN adaptor, a VPN adaptor, and a TAP/TUN adaptor.

Bus 1016 is an electronic component that transfers data between other electronic components of or connected to example programmable electronic device 1000. Bus 1016 serves as a shared highway of communication for data and instructions (e.g., instructions 1018), providing a pathway for the exchange of information between components within example programmable electronic device 1000 or between example programmable electronic device 1000 and another device. Bus 1016 connects the different parts of example programmable electronic device 1000 to each other. In an embodiment, bus 1016 encompasses one or more of: a system bus, a front-side bus, a data bus, an address bus, a control bus, an expansion bus, a universal serial bus (USB), a I/O bus, a memory bus, an internal bus, an external bus, and a network bus.

Instructions 1018 are computer-processable instructions that take different forms. In an embodiment, instructions 1018 are in a low-level form such as binary instructions, assembly language, or machine code according to an instruction set (e.g., x86, ARM, MIPS) that processor 1002 is designed to process. In an embodiment, instructions 1018 include individual operations that processor 1002 is designed to perform such as arithmetic operations (e.g., add, subtract, multiply, divide, etc.); logical operations (e.g., AND, OR, NOT, XOR, etc.); data transfer operations including moving data from one location to another such as from memory 1004 into a register of processor 1002 or from a register to memory 1004; control instructions such as jumps, branches, calls, and returns; comparison operations; and specialization operations such as handling interrupts, floating-point arithmetic, and vector and matrix operations. In an embodiment, instructions 1018 are in a higher-level form such as programming language instructions in a high-level programming language such as Python, Java, C++, etc. In an embodiment, instructions 1018 are in an intermediate level form in between a higher-level form and a low-level form such as bytecode or an abstract syntax tree (AST).

Instructions 1018 for processing by processor 1002 are in different forms at the same or different times. In an embodiment, when stored in mass data storage 1012 or memory 1004, instructions 1018 are stored in a higher-level form such as Python, Java, or other high-level programing language instructions, in an intermediate-level form such as Python or Java bytecode that is compiled from the programming language instructions, or in a low-level form such as binary code or machine code. In an embodiment, when stored in processor 1002, instructions 1018 are stored in a low-level form such as binary instructions, assembly language, or machine code according to an instruction set architecture (ISA). In an embodiment, instructions 1018 are stored in processor 1002 in an intermediate level form or even a high-level form where CPU 1002 processes instructions in such form.

Instructions 1018 are processed by one or more processors of example programmable electronic device 1000 using a processing model such as any or all of the following processing models: sequential execution where instructions are processed one after another in a sequential manner; pipelining where pipelines are used to process multiple instruction phases concurrently; multiprocessing where different processors different instructions concurrently, sharing the workload; thread-level parallelism where multiple threads run in parallel across different processors; simultaneous multithreading or hyperthreading where a single processor processes multiple threads simultaneously, making it appear as multiple logical processors; multiple instruction issue where multiple instruction pipelines allow for the processing of several instructions during a single clock cycle; parallel data operations where a single instruction is used to perform operations on multiple data elements concurrently; clustered or distributed computing where multiple processors in a network (e.g., in the cloud) collaboratively process the instructions, distributing the workload across the network; graphics processing unit (GPU) acceleration where GPUs with their many processors allow the processing of numerous threads in parallel, suitable for tasks like graphics rendering and machine learning; asynchronous execution where processing of instructions is driven by events or interrupts, allowing the one or more processors to handle tasks asynchronously; concurrent instruction phases where multiple instruction phases (e.g., fetch, decode, execute) of different instructions are handled concurrently; parallel task processing where different processors handle different tasks or different parts of data, allowing for concurrent processing and execution; or any other processing model suitable to meet the requirements of the particular implementation at hand.

Network 1022 is a collection of interconnected computers, servers, and other programmable electronic devices that allow for the sharing of resources and information. Network 1022 ranges in size from just two connected devices to a global network (e.g., the internet) with many interconnected devices. In an embodiment, network 1022 encompasses network devices such as routers, switches, hubs, modems, and access points.

Individual devices on network 1022 are sometimes referred to as “network nodes.” Network nodes communicate with each other through mediums or channels sometimes referred to as “network communication links.” The network communication links are wired (e.g., twisted-pair cables, coaxial cables, or fiber-optic cables) or wireless (e.g., Wi-Fi, radio waves, or satellite links). Network nodes follow a set of rules sometimes referred to “network protocols” that define how the network nodes communicate with each other. Example network protocols include data link layer protocols such as Ethernet and Wi-Fi, network layer protocols such as IP (Internet Protocol), transport layer protocols such as TCP (Transmission Control Protocol), application layer protocols such as HTTP (Hypertext transfer Protocol) and HTTPS (HTTP Secure), and routing protocols such as OSPF (Open Shortest Path First) and BGP (Border Gateway Protocol).

Network 1022 has a particular physical or logical layout or arrangement sometimes referred to as a “network topology.” Example network topologies include bus, star, ring, and mesh. In an embodiment, network 1022 encompasses any or all of the following categories of networks: a personal area network (PAN) that covers a small area (a few meters), like a connection between a computer and a peripheral device via Bluetooth; a local area network (LAN) that covers a limited area, such as a home, office, or campus; a metropolitan area network (MAN) that covers a larger geographical area, like a city or a large campus; a wide area network (WAN) that spans large distances, often covering regions, countries, or even globally (e.g., the internet); a virtual private network (VPN) that provides a secure, encrypted network that allows remote devices to connect to a LAN over a WAN; an enterprise private network (EPN) build for an enterprise, connecting multiple branches or locations of a company; or a storage area network (SAN) that provides specialized, high-speed block-level network access to storage using high-speed network links like Fibre Channel.

### Terminology

As used herein and in the appended claims, the term “computer-readable media” refers to one or more mediums or devices that store or transmit information in a format that a computer system accesses. Computer-readable media encompasses both storage media and transmission media. Storage media includes volatile and non-volatile memory devices such as RAM devices, ROM devices, secondary storage devices, register memory devices, memory controller devices, graphics memory devices, and the like. Transmission media includes wired and wireless physical pathways that carry communication signals such as twisted pair cable, coaxial cable, fiber optic cable, radio waves, microwaves, infrared, visible light communication, and the like.

As used herein and in the appended claims, the term “non-transitory computer-readable media” encompasses computer-readable media as just defined but excludes transitory, propagating signals. Data stored on non-transitory computer-readable media isn't just momentarily present and fleeting but has some degree of persistence. For example, instructions stored in a hard drive, a SSD, an optical disk, a flash drive, or other storage media are stored on non-transitory computer-readable media. Conversely, data carried by a transient electrical or electromagnetic signal or wave is not stored in non-transitory computer-readable media when so carried.

As used herein and in the appended claims, unless otherwise clear in context, the terms “comprising,” “having,” “containing,” “including,” “encompassing,” “in response to,” “based on,” and the like are intended to be open-ended in that an element or elements following such a term is not meant to be an exhaustive listing of elements or meant to be limited to only the listed element or elements.

Unless otherwise clear in context, relational terms such as “first” and “second” are used herein and in the appended claims to differentiate one thing from another without limiting those things to a particular order or relationship. For example, unless otherwise clear in context, a “first device” could be termed a “second device.” The first and second devices are both devices, but not the same device.

Unless otherwise clear in context, the indefinite articles “a” and “an” are used herein and in the appended claims to mean “one or more” or “at least one.” For example, unless otherwise clear in context, “in an embodiment” means in at least one embodiment, but not necessarily more than one embodiment. Accordingly, unless otherwise clear in context, phrases such as “a device configured to” are intended to include one or more recited devices. Such one or more recited devices, unless otherwise clear in context, are collectively configured to carry out the stated recitations. For example, “a processor configured to carry out recitations A, B and C” encompasses both (a) a single processor configured to carry out recitations A, B, and C and (b) a first processor configured to carry out recitation A working in conjunction with a second processor configured to carry out recitations B and C.

Unless otherwise clear in context, the terms “set,” and “collection” should generally be interpreted to include one or more described items throughout this application. Accordingly, unless otherwise clear in context, phrases such as “a set of devices configured to” or “a collection of devices configured to” are intended to include one or more recited devices. Such one or more recited devices, unless otherwise clear in context, are collectively configured to carry out the stated recitations. For example, “a set of servers configured to carry out recitations A, B and C” encompasses both (a) a single server configured to carry out recitations A, B, and C and (b) a first server configured to carry out recitations A and B working in conjunction with a second server configured to carry out recitation C.

As used herein, unless otherwise clear in context, the term “or” is open-ended and encompasses all possible combinations, except where infeasible. For example, if it is stated that a component includes A or B, then, unless infeasible or otherwise clear in context, the component includes at least A, or at least B, or at least A and B. As a second example, if it is stated that a component includes A, B, or C then, unless infeasible or otherwise clear in context, the component includes at least A, or at least B, or at least C, or at least A and B, or at least A and C, or at least B and C, or at least A and B and C.

Unless the context clearly indicates otherwise, conjunctive language in this description and in the appended claims such as the phrase “at least one of X, Y, and Z,” is to be understood to convey that an item, term, etc. is either X, Y, or Z, or a combination thereof. Thus, such conjunctive language does not require that at least one of X, at least one of Y, and at least one of Z to each be present.

Unless the context clearly indicates otherwise, the relational term “based on” is used in this description and in the appended claims in an open-ended fashion to describe a logical (e.g., a condition precedent) or causal connection or association between two stated things where one of the things is the basis for or informs the other without requiring or foreclosing additional unstated things that affect the logical or casual connection or association between the two stated things.

Unless the context clearly indicates otherwise, the relational term “in response to” or “responsive to” is used in this description and in the appended claims in an open-ended fashion to describe a stated action or behavior that is done as a reaction or reply to a stated stimulus without requiring or foreclosing additional unstated stimuli that affect the relationship between the stated action or behavior and the stated stimulus.

### PRIVACY

In an embodiment, the techniques described herein are implemented with privacy safeguards to protect user privacy. Furthermore, in an embodiment, the techniques described herein are implemented with user privacy safeguards to prevent unauthorized access to personal data and confidential data. The training of the artificial intelligence (“AI”) models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, in an embodiment, users have full control over the visibility of their content and who sees their content, as is controlled via the visibility settings. According to the techniques described herein, in an embodiment, users have full control over the level of their personal data that is shared and distributed between different AI platforms that provide different functionalities. According to the techniques described herein, in an embodiment, users have full control over the level of access to their personal data that is shared with other parties. According to the techniques described herein, personal data provided by users is, in an embodiment, processed to determine prompts when using a generative AI feature at the request of the user, but not to train generative AI models. In an embodiment, users provide feedback while using the techniques described herein, which are used to improve or modify the platform and products. In an embodiment, any personal data associated with a user, such as personal information provided by the user to the platform, is deleted from storage upon user request. In an embodiment, personal information associated with a user is permanently deleted from storage when a user deletes their account from the platform.

According to the techniques described herein, personal data is, in an embodiment, removed from any training dataset that is used to train AI models. The techniques described herein, in an embodiment, utilize tools for anonymizing member and customer data. For example, user's personal data is, in an embodiment, redacted and minimized in training datasets for training AI models through delexicalisation tools and other privacy enhancing tools for safeguarding user data. The techniques described herein, in an embodiment, minimize use of any personal data in training AI models, including removing and replacing personal data. According to the techniques described herein, notices are, in an embodiment, communicated to users to inform how their data is being used and users are provided controls to opt-out from their data being used for training AI models.

According to some embodiments, tools are used with the techniques described herein to identify and mitigate risks associated with AI in all products and AI systems. In an embodiment, notices are provided to users when AI tools are being used to provide features.

What is claimed is:

1. A method comprising:
using a set of large language model prompts to prompt a large language model to generate a set of completions; wherein each completion of the set of completions is generated by the large language model in response to a respective large language model prompt of the set of large language model prompts;
obtaining a set of engagement content items for a set of anchor content items from the set of completions;
training a dialogue classifier based on a set of dialogue examples to yield a trained dialogue classifier, the set of dialogue examples comprising the set of anchor content items and the set of engagement content items;
using the trained dialogue classifier to determine a respective dialogue score for each dialogue of a set of dialogues; wherein each dialogue of the set of dialogues comprises a respective anchor content item and a respective engagement content item associated with the respective anchor content item;
selecting a respective engagement content item of a particular dialogue of the set of dialogues based on the respective dialogue score for the particular dialogue; and
causing at least a portion of the respective engagement content item of the particular dialogue to be presented in a graphical user interface as a highlighted engagement content item.

2. The method of claim 1, wherein:
each large language model prompt of the set of large language model prompts instructs the large language model to generate a number of engagement content items for a respective anchor content item of the set of anchor content items;
each large language model prompt of the set of large language model prompts comprises a respective set of engagement content item specifications; and
each engagement content item specification of the respective set of engagement content item specifications of each large language model prompt of the set of large language model prompts comprises a respective set of features of a respective engagement content item to be generated by the large language model.

3. The method of claim 2, wherein, for each engagement content item specification of the respective set of engagement content item specifications of each large language model prompt of the set of large language model prompts, the respective set of features of the respective engagement content item to be generated by the large language model comprises one or more of:
a length of the respective engagement content item to be generated by the large language model,
a specification that the respective engagement content item to be generated by the large language model is to comment on a particular point made in the respective anchor content item,
a specification that the respective engagement content item to be generated by the large language model is to comment on an overall topic of the respective anchor content item,
a specification that the respective engagement content item to be generated by the large language model is to have a social interaction with an author of the respective anchor content item,
an engagement content item depth type of the respective engagement content item to be generated by the large language model, or
an engagement content item tone of the respective engagement content item to be generated by the large language model.

4. The method of claim 1, wherein:
the trained dialogue classifier comprises a first trained bidirectional encoder representations from transformers model, a second trained bidirectional encoder representations from transformers model, and a trained fully connected layer; and
wherein using the trained dialogue classifier to determine the respective dialogue score for the particular dialogue comprises inputting the engagement content item of the particular dialogue into the first trained bidirectional encoder representations from transformers model, and inputting the anchor content item of the particular dialogue into the second trained bidirectional encoder representations from transformers model.

5. The method of claim 1, wherein:
the trained dialogue classifier comprises a trained bidirectional encoder representations from transformers model and a trained fully connected layer; and
wherein using the trained dialogue classifier to determine the respective dialogue score for the particular dialogue comprises separately inputting both the engagement content item of the particular dialogue and the anchor content item of the particular dialogue into the trained bidirectional encoder representations from transformers model.

6. The method of claim 1, wherein the graphical user interface comprises a feed item, a notifications item, or an electronic mail message item; and wherein the engagement content item of the particular dialogue is presented as the highlighted engagement content item in the feed item, the notifications item, or the electronic mail message item.

7. The method of claim 1, wherein:
each dialog example, of the set of dialogue examples, corresponds to an anchor content item of the set of anchor content items;
each dialog example, of the set of dialogue examples, comprises an engagement content item, of the set of engagement content items, generated by the large language model for the anchor content item to which the dialog example corresponds;
the set of dialog examples are associated with a set of labels;
each label, of the set of labels, labels a respective dialog example of the set of dialog examples; and
each label, of the set of labels, indicates whether the engagement content item of the respective dialog example is an insightful comment on the anchor content item to which the respective dialog example corresponds.

8. A system comprising:
at least one processor;
memory; and
instructions stored in the memory to be executed by the at least one processor for:
using a set of large language model prompts to prompt a large language model to generate a set of completions; wherein each completion of the set of completions is to be generated by the large language model in response to a respective large language model prompt of the set of large language model prompts;
obtaining a set of engagement content items for a set of anchor content items from the set of completions;
training a dialogue classifier based on a set of dialogue examples to yield a trained dialogue classifier, the set of dialogue examples to comprise the set of anchor content items and the set of engagement content items;
using the trained dialogue classifier to determine a respective dialogue score for each dialogue of a set of dialogues; wherein each dialogue of the set of dialogues is to comprise a respective anchor content item and a respective engagement content item associated with the respective anchor content item;
selecting an engagement content item of a particular dialogue of the set of dialogues based on the respective dialogue score for the particular dialogue; and
causing at least a portion of the engagement content item of the particular dialogue to be presented in a graphical user interface as a highlighted engagement content item.

9. The system of claim 8, wherein:
each large language model prompt of the set of large language model prompts is to instruct the large language model to generate a number of engagement content items for a respective anchor content item of the set of anchor content items;
each large language model prompt of the set of large language model prompts is to comprise a respective set of engagement content item specifications; and
each engagement content item specification of the respective set of engagement content item specifications of each large language model prompt of the set of large language model prompts is to comprise a respective set of features of a respective engagement content item to be generated by the large language model.

10. The system of claim 9, wherein, for each engagement content item specification of the respective set of engagement content item specifications of each large language model prompt of the set of large language model prompts, the respective set of features of the respective engagement content item to be generated by the large language model is to comprise one or more of:
a length of the respective engagement content item to be generated by the large language model,
a specification that the respective engagement content item to be generated by the large language model is to comment on a particular point made in the respective anchor content item,
a specification that the respective engagement content item to be generated by the large language model is to comment on an overall topic of the respective anchor content item,
a specification that the respective engagement content item to be generated by the large language model is to have a social interaction with an author of the respective anchor content item,
an engagement content item depth type of the respective engagement content item to be generated by the large language model, or
an engagement content item tone of the respective engagement content item to be generated by the large language model.

11. The system of claim 8, wherein:
the trained dialogue classifier is to comprise a first trained bidirectional encoder representations from transformers model, a second trained bidirectional encoder representations from transformers model, and a trained fully connected layer; and
wherein using the trained dialogue classifier to determine the respective dialogue score for the particular dialogue is to comprise inputting the engagement content item of the particular dialogue into the first trained bidirectional encoder representations from transformers model, and inputting the anchor content item of the particular dialogue into the second trained bidirectional encoder representations from transformers model.

12. The system of claim 8, wherein:
the trained dialogue classifier is to comprise a trained bidirectional encoder representations from transformers model and a trained fully connected layer; and
wherein using the trained dialogue classifier to determine the respective dialogue score for the particular dialogue is to comprise separately inputting both the engagement content item of the particular dialogue and the anchor content item of the particular dialogue into the trained bidirectional encoder representations from transformers model.

13. The system of claim 8, wherein the graphical user interface comprises a feed item, a notifications item, or an electronic mail message item; and wherein the engagement content item of the particular dialogue is to be presented as the highlighted engagement content item in the feed item, the notifications item, or the electronic mail message item.

14. The system of claim 8, wherein:
each dialog example, of the set of dialogue examples, corresponds to an anchor content item of the set of anchor content items;
each dialog example, of the set of dialogue examples, is to comprise an engagement content item, of the set of engagement content items, generated by the large language model for the anchor content item to which the dialog example corresponds;
the set of dialog examples are to be associated with a set of labels;
each label, of the set of labels, is to label a respective dialog example of the set of dialog examples; and
each label, of the set of labels, is to indicate whether the engagement content item of the respective dialog example is an insightful comment on the anchor content item to which the respective dialog example corresponds.

15. A non-transitory computer-readable medium storing instructions which, when executed by at least one programmable electronic device, cause the at least one programmable electronic device to perform operations comprising:
using a set of large language model prompts to prompt a large language model to generate a set of completions; wherein each completion of the set of completions is generated by the large language model in response to a respective large language model prompt of the set of large language model prompts;
obtaining a set of comments for a set of posts from the set of completions;
training a dialogue classifier based on a set of dialogue examples to yield a trained dialogue classifier, the set of dialogue examples comprising the set of posts and the set of comments;
using the trained dialogue classifier to determine a respective dialogue score for each dialogue of a set of dialogues; wherein each dialogue of the set of dialogues comprises a respective post and a respective comment on the respective post;
selecting a comment of a particular dialogue of the set of dialogues based on the respective dialogue score for the particular dialogue; and
causing at least a portion of the comment of the particular dialogue to be presented in a graphical user interface as a highlighted comment.

16. The non-transitory computer-readable medium of claim 15, wherein:
each large language model prompt of the set of large language model prompts instructs the large language model to generate a number of comments for a respective post of the set of posts;
each large language model prompt of the set of large language model prompts comprises a set of comment specifications; and
each comment specification of the set of comment specifications of each large language model prompt of the set of large language model prompts comprises a respective set of features of a respective comment to be generated by the large language model.

17. The non-transitory computer-readable medium of claim 15, wherein, for each comment specification of the set of comment specifications of each large language model prompt of the set of large language model prompts, the respective set of features of the respective comment to be generated by the large language model comprises one or more of:
a length of the respective comment to be generated by the large language model,
a specification that the respective comment to be generated by the large language model is to comment on a particular point made in the respective post,
a specification that the respective comment to be generated by the large language model is to comment on an overall topic of the respective post,
a specification that the respective comment to be generated by the large language model is to have a social interaction with an author of the respective post,
a comment depth type of the respective comment to be generated by the large language model, or
a comment tone of the respective comment to be generated by the large language model.

18. The non-transitory computer-readable medium of claim 15, wherein:
the trained dialogue classifier comprises a first trained bidirectional encoder representations from transformers model, a second trained bidirectional encoder representations from transformers model, and a trained fully connected layer; and
wherein using the trained dialogue classifier to determine the respective dialogue score for the particular dialogue comprises inputting the comment of the particular dialogue into the first trained bidirectional encoder representations from transformers model, and inputting the post of the particular dialogue into the second trained bidirectional encoder representations from transformers model.

19. The non-transitory computer-readable medium of claim 15, wherein:
the trained dialogue classifier comprises a trained bidirectional encoder representations from transformers model and a trained fully connected layer; and
wherein using the trained dialogue classifier to determine the respective dialogue score for the particular dialogue comprises separately inputting both the comment of the particular dialogue and the post of the particular dialogue into the trained bidirectional encoder representations from transformers model.

20. The non-transitory computer-readable medium of claim 15, wherein the graphical user interface comprises a feed item, a notifications item, or an electronic mail message item; and wherein at least a portion of the comment of the particular dialogue is presented as the highlighted comment in the feed item, the notifications item, or the electronic mail message item.
